(19) United States
(12) Patent Application Publication
(10) Pub. No.: US 2012/0046066 A1
(43) Pub. Date: Feb. 23, 2012

(54) WIRELESS COMMUNICATION APPARATUS, WIRELESS COMMUNICATION BASE STATION, AND WIRELESS COMMUNICATION SYSTEM

(75) Inventors: Takashi Tamura, Kanagawa (JP); Takahisa Aoyama, Kanagawa (JP); Jun Hirano, Kanagawa (JP)

(73) Assignee: PANASONIC CORPORATION, Osaka (JP)

(21) Appl. No.: 13/257,892

(22) PCT Filed: Mar. 30, 2010
(86) PCT No.: PCT/JP2010/002337

§ 371 Date: Sep. 20, 2011

(30) Foreign Application Priority Data
Mar. 31, 2009 (JP) 2009086972

(51) Int. Cl. H04W 36/00; H04B 7/26; H04W 24/00; H04B 17/00

(52) U.S. Cl. 455/525; 455/67.11

(57) ABSTRACT

Provided is a wireless communication apparatus that transfers information required for a terminal, which performs a carrier aggregation, to be handed over to another base station, while reducing the size of a measurement result report. When establishing wireless communication with the wireless communication base station by use of a plurality of cells of the wireless communication base station, a controller provided in a wireless communication apparatus determines whether to control the measurement result report preparation section so as to prepare the measurement result report by grouping measurement results of at least two cells of the plurality of cells or to control the measurement result report preparation section so as to prepare the measurement result report while including the measurement results of the plurality of respective cells.

### TECHNICAL FIELD

The present invention relates to a wireless communication apparatus that enables use of a plurality of carrier frequencies originating from a wireless communication base station, a wireless communication base station to which the wireless communication apparatus is connected, and a wireless communication system.

### BACKGROUND ART

3GPP (The 3rd Generation Partnership Project) has pursued standardization of LTE (Long Term Evolution) as next-generation WCDMA (Wideband Code Division Multiple Access) communication standards (see; for instance, Non-Patent Literatures 1 through 3).

In LTE, a base station (E-UTRAN Node B that is hereunder referred to also as an “eNB”) of a network (Evolved Universal Mobile Radio Access Network that is hereinafter referred to also as an “E-UTRAN”) has a plurality of communication cells (hereunder referred to also as “cells”). A terminal (User Equipment that is hereinafter referred to also as an “UE”) belongs to one of the cells. A status of the terminal is classified into an idle (RRC_Idle) status in which a radio bearer is not established between the terminal and a base station and a connected status (RRC_Connected) in which the radio bearer is established between the terminal and the base station. When performing transmission and receipt of data, the terminal must change its status to the connected status.

FIG. 23 is a sequence chart for shifting the terminal from the idle status to the connected status. The terminal uses a random access procedure (Random Access Channel Procedures that are hereunder referred to also as “RACH procedures”) to synchronize with a base station. As shown in FIG. 23, the terminal sends a RACH signal to the base station, and the base station sends a RACH response message (RACH response) to the terminal in response to the RACH signal. The terminal can synchronize with the base station through the foregoing operation and becomes able to use signaling radio bearer 0 (hereinafter referred to also as “SRB0”) for transmitting and receiving a radio resource control message (hereinafter referred to also as an “RRC message”) by use of a common control channel (hereinafter referred to also as a “CCCH”).

In order to establish an RRC connection by use of SRB0, the terminal transmits an RRC connection request to the base station. In order to establish signaling radio bearer 1 (hereinafter referred to also as an “SRB1”) for transmitting and receiving an RRC message and a non-access stratum message (hereinafter referred to also as an “NAS message”) by use of an individual control channel (hereinafter referred to also as a “Dedicated Control Channel” or “DCCH”), the base station transmits an RRC connection setup to the terminal by use of SRB0. Upon receipt of the RRC connection setup, the terminal establishes SRB1.

In order to check successful establishment and completion of the RRC connection, the terminal sends an RRC connection setup complete message to the base station by use of SRB1. In order to validate AS security (Access Stratum Security), the base station transmits a security mode command by utilization of SRB1. Subsequently, when a security mode complete message transmitted from the terminal is received, AS Security between the terminal and the base station becomes valid.

Additionally, in order to prioritize transmission of the highly urgent RRC message (e.g., a Handover Command or a Measurement Report) over transmission of the less urgent NAS message (e.g., addition of service, and the like), the base station at this time establishes signaling radio bearer 2 (hereinafter referred to also as an “SRB2”) for transmitting and receiving a NAS message at priority that is lower than that of SRB1. The base station transmits an RRC connection reconfiguration message to the terminal, and the terminal receives the RRC connection reconfiguration message, whereupon SRB2 is established. In order to check successful completion of RRC connection reconfiguration, the terminal transmits an RRC connection reconfiguration complete message to the base station by use of SRB1.

RRC connection reconfiguration includes information about setting of data radio bearer (hereinafter referred to also as a “DRB”) for transmitting and receiving data between the terminal and the base station. The terminal establishes DRB by means of RRC connection reconfiguration. As above, the terminal can shift to the connected status.

When the terminal in the connected status moves to the outside of the cell, there is used a handover (hereinafter also referred to as an “HO”) technique by means of which the terminal switches a communication with its-own cell to a communication with another cell in order to prevent occurrence of communication disconnection. FIG. 24 is a sequence chart showing example handover. The terminal measures received power or receiving quality in accordance with a measurement configuration (hereinafter referred to also as “Measurement Configuration” or “MC”) of a received signal included in RRC Connection Reconfiguration. When an event (e.g., received power exceeds a preset threshold value) of transmission of a measurement result report (hereinafter also referred to as Measurement Report or “MR”) has occurred, the terminal transmits a measurement result as a measurement result report (a Measurement Report) to a connected base station (hereinafter also referred to as “Source eNB”). The Source eNB determines a base station (hereinafter also referred to as a “Target eNB”) that will be a handover destination for the terminal in accordance with the measurement result report (Measurement Report). In order to transmit a handover request and information required for handover to the Target eNB, the Source eNB transmits the handover request to the Target eNB.

Upon receipt of the handover request, the Target eNB prepares a handover command including a measurement configuration, mobility control information, a radio resource configuration, a security configuration, and the like, and transmits the thus-prepared handover command as a handover request response (Handover Request Ack) to the Source eNB. Upon receipt of the handover command from the Target eNB, the Source eNB transmits the handover command as it is to the UE. The Source eNB sends a DL allocation signal to the UE at this time. The Source eNB also transfers a sequence number (hereinafter also referred to as “SN”) of a data packet to be first sent to the terminal, among sequence numbers of data packets that have not yet been transmitted to the UE, to the Target eNB and additionally transfers data, which are to be sent to the UE, to the Target eNB.

The UE synchronizes with the Target eNB by use of the RACH procedure; transmits a handover confirmation to the Target eNB; and then completes handover. As mentioned above, the UE in a connected status can switch communication from the base station that is in communication to another base station without involvement of communication disconnection.

The measurement configuration for letting the terminal measure received power and receiving quality include information, such as Measurement Identities (MeasID) that is an identifier showing measurement, Measurement Object (MeasObject) showing an objective of measurement, Quantity Configuration (QuantityConfig) showing operation for filtering measurement results and like operations, Reporting Configuration (ReportConfig) showing configuration of a measurement result report (Measurement Report), Quantity Configuration showing configuration of a value of a measurement result, Measurement Gap showing a duration during which data used for measuring another frequency or another system are not transmitted or received, and others. The measurement configuration is transmitted while being included in the RRC connection Reconfiguration. MeasID, MeasObject, and ReportConfig among the measurement configuration involve performance of cooperative operation.

FIG. 25 is a view showing an example measurement configuration of the terminal. As shown in FIG. 25, MeasID is an identifier showing measurement and used for identifying measurement implemented by combination of a MeasObject ID that is an identifier showing MeasObject and a ReportConfigID that is an identifier showing ReportConfig.

FIG. 26 is a view showing example MeasObject. MeasObject includes a down link carrier frequency (EUTRA-DL-CarrierFreq), a bandwidth to be measured (MeasurementBandwidth), the frequency offset (OffsetFreq), a list of cells to be removed from a list of neighbor cells (CellsToRemovList), a list of cells to be added or modified to neighbor cells (CellsToAddModifyList), a list of cells to be removed from a list of blacklisted cells (BlackListedCellsToRemoveList), and a list of cells to be added or modified to blacklisted cells (BlackListedCellsToAddModifyList). ReportConfig includes types of triggers for a measurement result report, trigger quantity, report quantity, the maximum number of cells to be reported, a report period, a volume of report (report Amount), and the like.

A way to send a measurement result report (Measurement Report) includes transmission of a report at the time of occurrence of an event (event trigger reporting), periodic transmission of a report (periodic reporting), and periodic transmission of a report after occurrence of an event (event trigger periodic reporting). Types of E-UTRAN events include five types of events; for instance, an event representing that a serving cell is greater than a threshold value; an event representing that a serving cell is smaller than a threshold value; an event representing that a neighbor cell is superior to a serving cell; an event representing that a neighbor cell is superior to a threshold value; and an event representing that a serving cell is inferior to a threshold value 1 and that a neighbor cell is superior to a threshold value 2.

FIG. 27 is a view showing an example measurement report. In the example measurement report shown in FIG. 27, a header of the report includes information; namely, MeasID, reference signal received power (hereinafter referred to also as an “RSRP”) of a serving cell, and reference signal received quality (hereinafter referred to also as an “RSRQ”) of a serving cell. A subsequent portion of the report includes information about a neighbor cell. A physical cell identifier (hereinafter referred to also as “PCI”) has been written in information about a neighbor cell, and information; namely, a global cell identifier (hereinafter referred to also as a Global Cell Identity or “CGI”), a tracking area code, and a public land mobile network identity list (hereinafter referred to also as a “PLMN list”) is also optionally included in the information. Information about the neighbor cell optionally includes RSRP information and RSRQ information. When there are plurality of neighbor cells, information about the plurality of neighbor cells is included. As shown in FIG. 27, information about a first neighbor cell is followed by information about the next neighbor cell. The terminal performs measurement represented by the MeasID and transmits a measurement report to the base station. The base station determines whether to perform handover in accordance with the measurement report (whether to perform handover to which one of the cells if handover is performed). When handover is performed, handover procedures are commenced.

### CITATION LIST

### Non-Patent Literature

Non-Patent Literature 1; 3GPP TS36.331 v8.4.0 “Evolved Universal Terrestrial Radio Access (E-UTRA) Radio Resource Control (RRC)”

Non-Patent Literature 2: 3GPP TS36.300 v8.7.0 “Evolved Universal Terrestrial Radio Access (E-UTRA) and Evolved Universal Terrestrial Radio Access Network (E-UTRAN); Overall description; Stage 2”

Non-Patent Literature 3: 3GPP TS25.331 v8.5.0 “Radio Resource Control (RRC); Protocol specification”

### SUMMARY OF THE INVENTION

### Technical Problem

The 3GPP pursues standardization of LTE-A (LTE-Advanced) as the next generation wireless communication standards compliant with LTE. Carrier aggregation (also called band aggregation) by means of which a terminal uses a plurality of carrier frequencies belonging to one base station has also been considered to be introduced into LTE-A.

FIG. 28 is an illustration showing an example general view of carrier aggregation. In FIG. 28, (a) is an illustration showing a component carrier frequency exchanged between a base station and a terminal, and in FIG. 28, (b) is an illustration showing portions of the component carriers used in carrier aggregation shown in (a) of FIG. 28. As shown in (a) and (b) of FIG. 28, there is shown an example in which a terminal uses; for instance, two component carriers having carrier frequencies f1 and f2 among three component carriers (having carrier frequencies f1, f2, and f3). As illustrated, as a result of use of the plurality of component carriers, enhancement of communication throughput accomplished between the terminal and the base station is expected.

However, under the related art method, occurrence of an event of transmission of a measurement result report (Measurement Report) is determined by comparison of its-own cell with another cell. Hence, when a plurality of carrier frequencies are used by means of carrier aggregation, there arises a situation equivalent to a case where its-own two cells exist. One of its-own cells induces an event of transmission of a measurement result report (Measurement Report), whereupon the terminal transmits the measurement result report to the base station. When the base station determines occurrence of a handover according to the measurement result report, a status of the remaining its-own cell is not taken into account at all. Hence, there arises a problem of appropriate handover being not performed.

Accordingly, another conceivable measure is to adopt a method under which the base station requests the terminal to transmit a measurement result report determined on the basis of the other its-own cell. In that case, there are required operation for transmitting RRC Connection Reconfiguration from the base station and receipt of a measurement result report determined on the basis of the other its-own cell from the terminal before the base station receives a measurement result report of the other its-own cell; hence, there arises a problem of handover involving consumption of a longer time (contrary to a demand for shortening a handover time as much as possible).

According to the technique described in connection with Non-Patent Literature 3, introduction of Additional measurement identities used in UMTS (Universal Mobile Telecommunication System) has been conceived. In relation to the measurement configuration, the UMTS has a setting item called an “Additional measurement identities.” The additional measurement identities represent a reference list for another measurement. When a measurement result report (Measurement Report) pertaining to measurement is transmitted, a result (reporting quality) of measurement used for reference is also included. However, under the method using the technique described in connection with Non-Patent Literature 3, a plurality of measurement results pertaining to an independent measurement configuration are included in the measurement result report (Measurement Report). The size of the measurement result report (Measurement Report) therefore becomes larger, which in turn results in an increase in traffic volume.

The present invention aims at providing, in connection with a wireless communication system that carries out communication by utilization of a plurality of component carriers, a wireless communication apparatus, a wireless communication base station, and a wireless communication system that make it possible to reduce a traffic volume by reducing a size of a measurement result report transmitted by the wireless communication apparatus to the wireless communication base station.

### Solution to Problem

A wireless communication apparatus according to the present invention includes: a receiver that receives a reference signal and control information including a measurement configuration from a wireless communication base station; a measurement result report determination section that determines, from a measurement result of the reference signal measured on a per-cell basis in accordance with the measurement configuration, whether or not to transmit a measurement result report to the wireless communication base station; a measurement result report preparation section that prepares the measurement result report to be reported to the wireless communication base station; a controller that controls the measurement result report determination section and the measurement result report preparation section in accordance with the control information; and a transmitter that transmits the measurement result report to the wireless communication base station, wherein, when establishing wireless communication with the wireless communication base station by use of a plurality of cells of the wireless communication base station, the controller determines whether to control the measurement result report preparation section so as to prepare the measurement result report by grouping measurement results of at least two cells of the plurality of cells or to control the measurement result report preparation section so as to prepare the measurement result report while including the measurement results of the plurality of respective cells.

In the wireless communication apparatus, the controller further includes an its-own base station subordinate cell list manager that manages a list of cells, among the plurality of cells, subordinate to a wireless communication base station to which the wireless communication apparatus itself is connected, the controller controls the measurement result report preparation section so as to prepare the measurement result report while including the measurement results of respective cells, among the plurality of cells, subordinate to the wireless communication base station to which the wireless communication apparatus itself is connected, and the controller determines whether to control the measurement result report preparation section so as to prepare the measurement result report by grouping measurement results of at least two cells, among the plurality of cells, that are not subordinate to the wireless communication base station to which the wireless communication apparatus itself is connected or to control the measurement result report preparation section so as to prepare the measurement result report while including the measurement results of the respective cells.

In the wireless communication apparatus, the controller further includes a base station subordinate cell list manager that manages a list of its-own base station cells subordinate to a wireless communication base station to which the wireless communication apparatus itself is connected and a list of other base station cells subordinate to another wireless communication base station to which the wireless communication apparatus itself is not connected, and the controller determines whether to control the measurement result report preparation section so as to prepare the measurement result report by grouping measurement results of at least two cells of the plurality of cells in accordance with a measurement result of the reference signal, and the list of its-own base station and the list of other base station cells managed by the base station subordinate cell list manager or to control the measurement result report preparation section so as to prepare the measurement result report while including the measurement results of the plurality of respective cells.

A wireless communication apparatus according to the present invention includes: a receiver that receives a reference signal and control information from a wireless communication base station; a measurement result report determination section that determines, from a measurement result of the reference signal measured in accordance with a predetermined measurement configuration, whether or not to transmit a measurement result report to the wireless communication base station; a measurement result report preparation section that prepares the measurement result report to be reported to the wireless communication base station; a controller that controls the measurement result report determination section and the measurement result report preparation section in accordance with the control information; and a transmitter that transmits the measurement result report to the wireless communication base station, wherein, when establishing wireless communication with the wireless communication base station by use of a plurality of cells of the wireless communication base station, the measurement result report determination section determines whether or not to transmit the measurement result report to the wireless communication base station in accordance with a value into which the measurement results of at least two cells of the plurality of cells are grouped.

In the wireless communication apparatus, the controller further includes an its-own base station subordinate cell list manager that manages a list of cells, among the plurality of cells, subordinate to a wireless communication base station to which the wireless communication apparatus itself is connected, the controller controls the measurement result report determination section in accordance with the measurement results of respective cells, among the plurality of cells, subordinate to the wireless communication base station to which the wireless communication apparatus itself is connected and the control information, and the measurement result report determination section determines whether or not to transmit the measurement result report to the wireless communication base station in accordance with a value obtained by grouping measurement results of at least two cells, among the plurality of cells, not subordinate to the wireless communication base station to which the wireless communication apparatus itself is connected, and also determines whether or not to transmit the measurement result report to the wireless communication base station in accordance with measurement results of respective cells, among the plurality of cells, subordinate to the wireless communication base station to which the wireless communication apparatus itself is connected.

In the wireless communication apparatus, the controller further includes a base station subordinate cell list manager that manages a list of its-own base station cells, among the plurality of cells, subordinate to the wireless communication base station to which the wireless communication apparatus itself is connected and a list of other base station cells, among the plurality of cells, subordinate to another wireless communication base station to which the wireless communication apparatus itself is not connected, the controller controls the measurement result report determination section in accordance with the control information and the list of its-own base station cell and the list of other base station cell managed by the base station subordinate cell list manager, and the measurement result report determination section determines whether or not to transmit the measurement result report to the wireless communication base station in accordance with a value into which the measurement results pertaining to at least two cells of the plurality of cells are grouped and a value into which the measurement results of at least two cells are grouped.

A wireless communication base station according to the present invention includes a receiver that receives the measurement result report transmitted from the transmitter of the wireless communication apparatus and a handover determination processor that determines whether or not to change a communication destination of the wireless communication apparatus from a cell of the current communication destination to another cell in accordance with the measurement result report received by the receiver.

A wireless communication system according to the present invention includes a wireless communication apparatus including; a receiver that receives a reference signal and control information including a predetermined measurement configuration from a wireless communication base station; a measurement result report determination section that determines, from a measurement result of the reference signal measured on a per-frequency basis in accordance with the predetermined measurement configuration, whether or not to transmit a measurement result report to the wireless communication base station; a measurement result report preparation section that prepares the measurement result report to be reported to the wireless communication base station; a controller that controls the measurement result report determination section and the measurement result report preparation section in accordance with the control information; and a transmitter that transmits the measurement result report to the wireless communication base station, wherein, when establishing wireless communication with the wireless communication base station by use of a plurality of cells of the wireless communication base station, the controller determines whether to control the measurement result report preparation section so as to prepare the measurement result report by grouping measurement results of at least two cells of the plurality of cells or to control the measurement result report preparation section so as to prepare the measurement result report while including measurement results of the plurality of respective cells. The wireless communication system further includes a wireless communication base station including: a receiver that receives the measurement result report transmitted from the transmitter of the wireless communication apparatus; and a handover determination processor that determines whether or not to change a communication destination of the wireless communication apparatus from a cell of the current communication destination to another cell in accordance with the measurement result report received by the receiver.

### Advantageous Effects of the Invention

In accordance with the wireless communication apparatus, the wireless communication base station, and the wireless communication system according to the present invention, the wireless communication base station can determine whether or not to perform handover by means of information included in the measurement result report that the wireless communication apparatus has prepared, while reducing the size of the measurement result report. Hence, there is yielded an advantage of the wireless communication base station being able to quickly determine handover while reducing a traffic volume between the wireless communication apparatus and the wireless communication base station.

### BRIEF DESCRIPTION OF THE DRAWINGS

FIG. 1 is an illustration showing component carriers used for communication established between a base station and a plurality of terminals in an embodiment of the present invention.

FIG. 2 is schematic diagrams showing a plurality of cells managed by the base station in FIG. 1.

FIG. 3 is a flowchart for describing an overview of a wireless communication system of a first embodiment.

FIG. 4 is a block diagram showing a configuration of a terminal 100 according to the first embodiment.

FIG. 5 is a chart showing example MeasObject achieved during carrier aggregation in the communication system according to the first embodiment.

FIG. 6 is a chart showing another example MeasObject achieved during carrier aggregation in the communication system according to the first embodiment.

FIG. 7 is a flowchart showing a method for determining a measurement result report produced during carrier aggregation in the first embodiment.

FIG. 8 is an illustration showing an example pair of cells in the communication system according to the first embodiment.

FIG. 9 is a chart showing an example measurement result report (Measurement Report) not produced for each pair of cells in the first embodiment.

FIG. 10 is a chart showing an example measurement result report (Measurement Report) produced for each pair of cells in the first embodiment.

FIG. 11 is a chart showing an example measurement result report (Measurement Report) produced when a measurement result represented by a pair of cells and a measurement result represented by an individual cell mixedly exist.

FIG. 12 is a chart showing an example measurement result report (Measurement Report) produced when PCIs of the pair of cells in the communication system are not unified in the first embodiment.

FIG. 13 is a block diagram showing a configuration of a base station 200 according to the first embodiment.

FIG. 14 is a block diagram showing a configuration of a terminal 300 of a second embodiment of the invention.

FIG. 15 is an illustration showing an example pair of cells in a wireless communication system according to the second embodiment.

FIG. 16 is a block diagram showing a configuration of a base station 400 according to the second embodiment.

FIG. 17 is a block diagram showing a configuration of a terminal 500 of a third embodiment.

FIG. 18 is an illustration showing an example pair of cells in a wireless communication system according to the third embodiment.

FIG. 19 is a block diagram showing a configuration of a base station 600 according to the third embodiment.

FIG. 20 is a block diagram showing a configuration of a terminal 700 of a fourth embodiment.

FIG. 21 is a flowchart showing a method for determining a measurement result report achieved during carrier aggregation in connection with the first embodiment.

FIG. 22 is a block diagram showing a configuration of a base station 800 according to the fourth embodiment.

FIG. 23 is a sequence chart used when the terminal shifts from an idle status to a connected status.

FIG. 24 is an example sequence chart of handover.

FIG. 25 is a chart showing an example setting of measurement of the terminal.

FIG. 26 is a chart showing example MeasObject.

FIG. 27 is a chart showing an example measurement result report (Measurement Report).

In FIG. 28, (a) is an illustration showing a component carrier frequency used between a base station and a terminal, and (b) is an illustration showing portions of the component carriers used in carrier aggregation shown in (a) of FIG. 28.

### DESCRIPTION OF THE EMBODIMENTS

A wireless communication apparatus and a wireless communication base station of embodiments of the present invention are hereunder described in detail by reference to the drawings. Explanations are hereunder provided by means of taking, as an example, a wireless communication system implemented from a wireless communication apparatus (hereinafter called a “terminal”) and a wireless communication base station (hereinafter called a “base station”). One base station is assumed to configure a plurality of communication cells (also called “areas”). The communication cell is hereunder called simply a “cell.” In the following embodiments, constituent elements exhibiting the same functions are assigned the same reference numerals, and their repeated explanations are omitted here for brevity.

In the embodiments of the present invention, the term “cell” is a wireless network object that can be uniquely identified by a terminal device by means of an identifier sent from one base station to a geographical area.

Respective embodiments provided below are described on the basis of Long Term Evolution (LTE) and System Architecture Evolution (SAE) that are mobile communication techniques standardized by the 3GPP. However, the present invention is not limited to the standards specified by the 3GPP but can also be applied to wireless access techniques; for instance, a wireless LAN (Wireless Local Area Network), WiMAX (Worldwide Interoperability for Microwave Access) such as IEEE802.16, IEEE802.16e, or IEEE802.16m; 3GPP2; the Long Term Evolution Advanced (LTE-A); and a fourth-generation mobile communication technique.

In the following embodiment, an explanation is provided by means of taking as an example a wireless communication system that enables a base station and a terminal to establish communication by utilization of a plurality of frequencies (e.g., two frequencies f1 and f2). In this case, one base station configures a plurality of cells at a plurality of frequencies.

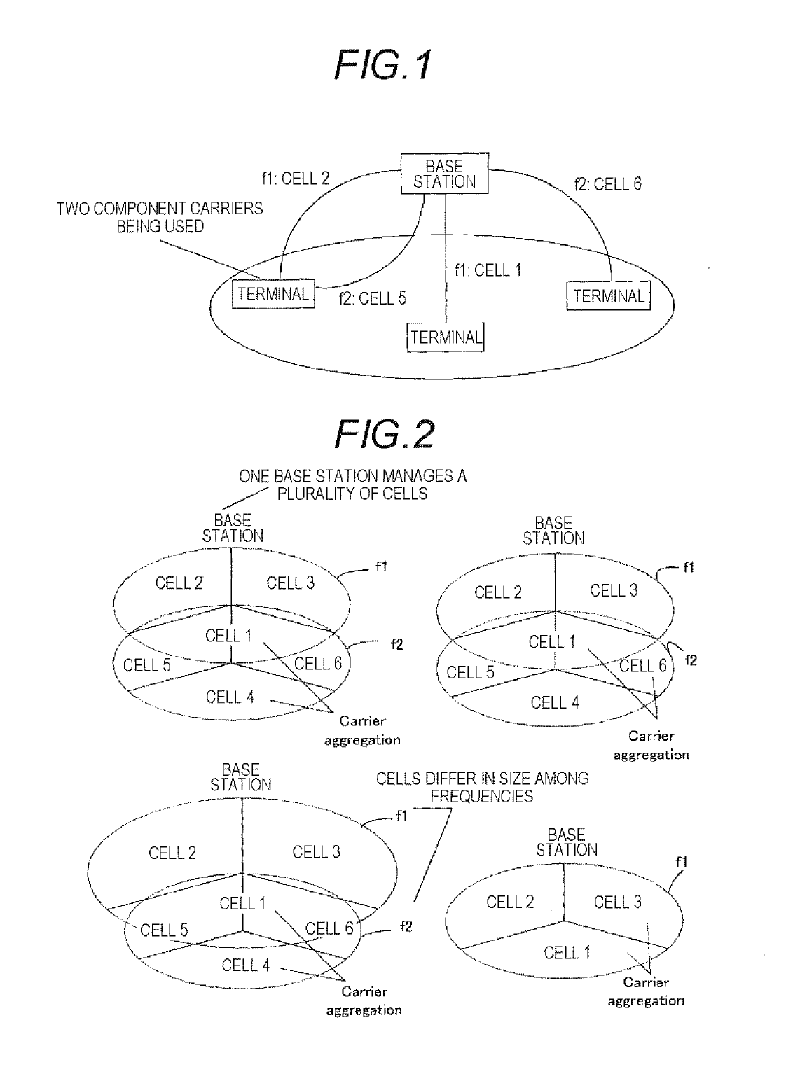

Carrier aggregation (also called “Band Aggregation”) is now described by reference to FIGS. 1 and 2. FIGS. 1 and 2 show a positional relationship between a base station and terminals in a wireless communication system according to an embodiment of the present invention. FIG. 1 is an illustration showing an example component carrier used for communication established between a base station and a plurality of terminals. FIG. 2 is schematic diagrams showing a plurality of cells managed by the base station in FIG. 1. As shown in FIGS. 1 and 2, the wireless communication system is formed of terminals (UE), such as portable phones and portable terminals, and a base station (eNB) that establishes communication with the terminals.

The base station manages a plurality of cells (e.g., three cells corresponding to a frequency f1 and three cells corresponding to a frequency f2) over a plurality of frequencies. The terminal can concurrently use component carriers of the plurality of cells. Concurrently using component carriers of the plurality of cells is called carrier aggregation. For instance, when component carriers of a plurality of different carrier frequencies belonging to the single base station are concurrently used, there may be a case where component carriers having a plurality of different carrier frequencies belonging to a single area of a single base station are concurrently used or a case where component carriers that have a plurality of different carrier frequencies and that belong to different areas of a single base station are concurrently used. Further, when cells of different sizes are managed, carrier aggregation is likewise carried out at frequencies of a different base station.

Further, there is a case where a plurality of component carriers having a single carrier frequency belonging to a different area of a single base station are used.

In the following embodiments, there are provided explanations about cases, as example carrier aggregation, where two component carriers (carrier frequencies f1 and f2) are used. However, the scope of the present invention is not confined to the case. For instance, three or more component carriers may also be used. Further, terminals located within the cell of the base station each use two component carriers through carrier aggregation. In some situations (according to the circumstances), one component carrier may also be used.

### First Embodiment

By reference to FIGS. 1 through 13, a wireless communication system according to a first embodiment of the present invention is now described. The wireless communication system according to the first embodiment of the present invention is includes a terminal 100 and a base station 200.

In the wireless communication system according to the first embodiment, the terminal 100 has a function of receiving a reference signal transmitted on a per-cell basis, by way of a downlink, from the base station 200 and reporting a measurement result, which has been derived according to a predetermined calculation formula, as a measurement result report (Measurement Report) to the base station 200 by way of an uplink. The base station 200 has a function of allocating and managing wireless resources (e.g., a frequency domain and a frequency band in a time domain) and carrying out handover when determined, from a measurement result report (Measurement Report) reported by the terminal 100, that handover to another cell is necessary. The base station can also be said to work as an access point in a wireless access network for the terminal 100.

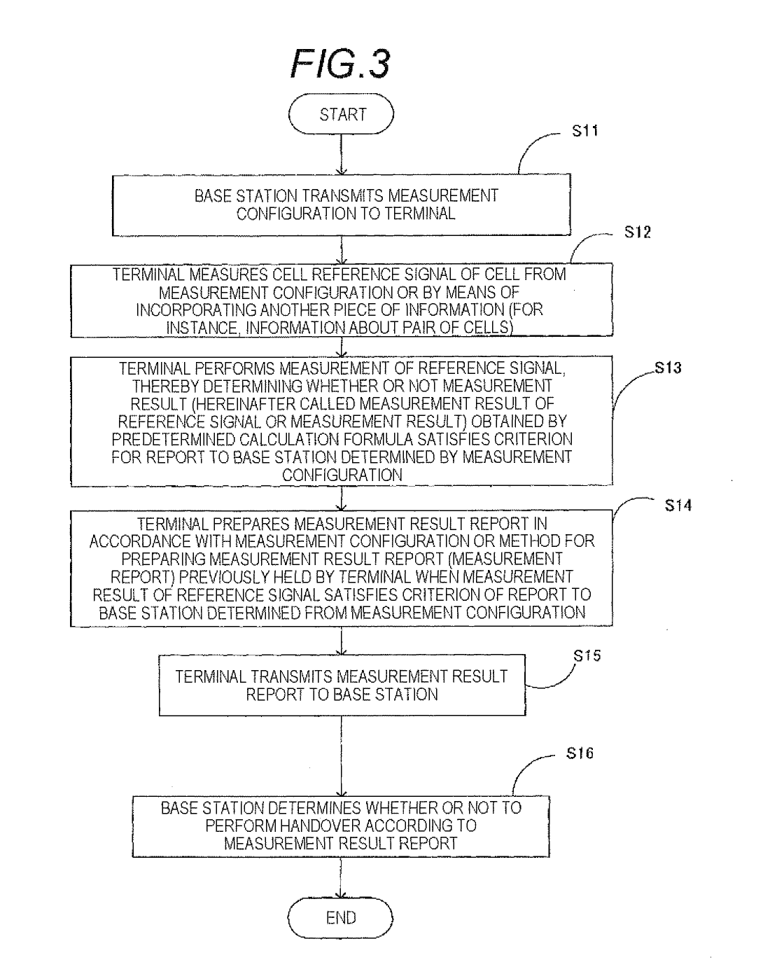

By reference to FIG. 3, an overview of the wireless communication system of the embodiment is now described. FIG. 3 is a flowchart for describing the overview of the wireless communication system according to the first embodiment.

In step S11, the base station 200 transmits a measurement configuration to the terminal 100. Processing proceeds to step S12. In step S12, the terminal 100 measures a cell reference signal in accordance with the measurement configuration transmitted from the base station 200 or by means of incorporating other information (e.g., information about a pair of cells and information about a list of cells subordinate to the base station) into the measurement configuration. Processing proceeds to step S13.

In step S13, the terminal 100 measures (measurement) a reference signal and determines whether or not a measurement result derived from the predetermined calculation formula (hereinafter called a “measurement result of the reference signal” or a “measurement result”) satisfies a criterion of a report to the base station 200 determined from the measurement configuration. When the measurement result of the reference signal satisfies the criterion for the report to the base station 200 determined from the measurement configuration, processing proceeds to step S14. On the contrary, when the measurement result of the reference signal does not satisfy the criterion of the report to the base station 200 determined from the measurement configuration, processing ends.

In step S14, since the measurement result of the reference signal satisfies the criterion of the report to the base station 200 determined from the measurement configuration, the terminal 100 prepares a measurement result report (Measurement Report) according to the measurement configuration or the method for preparing a measurement result report (Measurement Report) previously held in the terminal 100. Processing then proceeds to step S15.

In step S15, the terminal 100 transmits the measurement result report (Measurement Report) prepared in step S14 to the base station 200. Processing proceeds to step S16.

In step S16, the base station 200 determines, from the measurement result report (Measurement Report) transmitted from the terminal 100, whether or not to carry out handover.

[Configuration of the Terminal 100]

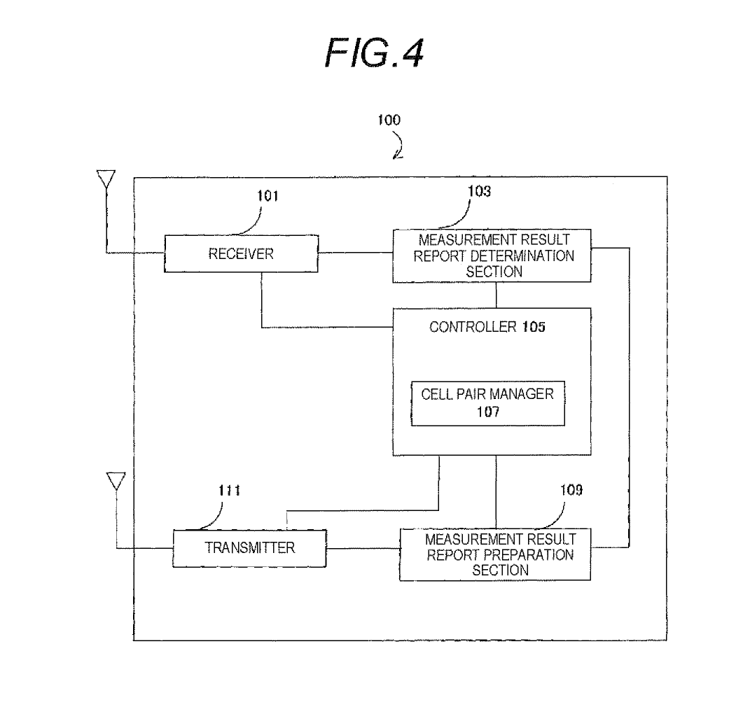

Referring to FIG. 4, the configuration of the terminal 100 according to the present embodiment is now described. FIG. 4 is a block diagram showing a configuration of the terminal 100 according to the first embodiment. The terminal 100 has a receiver 101, a measurement result report determination section 103, a controller 105, a measurement result report preparation section 109, and a transmitter 111.

The receiver 101 has a function of receiving system information, individual control information, and the like, transmitted from the connected base station 200 or another base station 200 in accordance with a command transmitted from the controller 105. The receiver 101 also has a function of receiving a reference signal transmitted from the connected base station 200 or another base station 200 in accordance with a command transmitted from the measurement result report determination section 103. The receiver outputs control information, such as system information and individual control information, to the controller and also outputs the reference signal to the measurement result report determination section 103.

The measurement result report determination section 103 has a function of individually managing commands to output various measurement results input by the controller 105. Commands to output measurement results input by the controller 105 include; for instance, a command to output a periodic measurement result, a command to output a measurement result at the time of occurrence of an event, a command to output a periodic measurement result after occurrence of an event, a command to output a measurement result achieved at a specific frequency, and a command to output a result of measurement of a specific cell. In accordance with a command from the controller 105, the measurement result report determination section 103 outputs to the receiver 103 a command to receive a reference signal. The measurement result report determination section 103 determines whether or not a measurement result of the input reference signal corresponds to the command from the controller 105. When determined that the input measurement result corresponds to the command, the measurement result report determination section 103 is configured so as to output a measurement result corresponding to the command to the measurement result report preparation section 109.

From information about a pair of cells input by the controller and the measurement configuration, the measurement result report determination section 103 determines whether to perform event determination by use of a value obtained by means of averaging the measurement results for the pair of cells or to perform event determination by use of a measurement result of an individual cell. In relation to event determination performed by use of the pair of cells, the measurement result report determination section 103 performs event determination by use of a value obtained by means of averaging measurement results for the pair of cells. In relation to event determination performed by use of a measurement result of an individual cell, the measurement result report determination section 103 performs event determination by use of a measurement result of an individual cell. Specifically, the measurement result report determination section has a function of determining, from information about a pair of cells and a measurement configuration, whether to perform event determination by use of a value obtained by means of averaging measurement results for the pair of cells or by use of a measurement result of an individual cell.

When the value obtained by averaging the measurement results for the pair of cells satisfies a criterion for transmitting measurement results to the base station 200, the measurement result report determination section 103 outputs, as a measurement result, a value obtained by averaging measurement results for the pair of cells to the measurement result report preparation section 109. Information necessary to prepare measurement results, such as the nature of a pair of cells, may also be output at this time to the measurement result report preparation section 109. As a result, when the measurement results do not include information about whether the measurement results are a value obtained by averaging the measurement results for the pair of cells or a measurement result of the individual cell, it is possible to easily determine that the measurement results are a value determined by averaging the measurement results for the pair of cells, at the time of preparation of a measurement result report.

In relation to an event that is not determined by use of a value obtained by averaging measurement results by means of the pair of cells, the measurement result report determination section 103 performs event determination from a measurement result of an individual cell. When a criterion for transmitting a measurement result of a cell to the base station 200 is satisfied, the measurement result is output to the measurement result report preparation section 109. The information necessary to prepare a measurement result report can also be output at this time to the measurement result report preparation section 109. With such a configuration, when the measurement results do not include information about whether the measurement results are a measurement result of the individual cell or a value obtained by averaging the measurement results for the pair of cells, it is possible to readily determine that the measurement result is a measurement result of the individual cell, at the time of preparation of a measurement result report.

Even after having output to the measurement result report preparation section 109 a measurement result and information necessary to prepare a measurement result report, the measurement result report determination section 103 performs measurement in accordance with a measurement configuration. The measurement result report determination section 103 can also output the measurement result and the information necessary to prepare a measurement result to the controller 105 without outputting the same to the measurement result report preparation section 109.

The controller 105 has a function of commanding the receiver 101 to receive system information, or the like, sent from the base station 200. The controller 105 has a function of outputting a measurement configuration based on control information output from the receiver 101 or previously incorporated control information to the measurement result report determination section 103 and commanding the measurement result report determination section 103 to output a measurement result based on the measurement configuration.

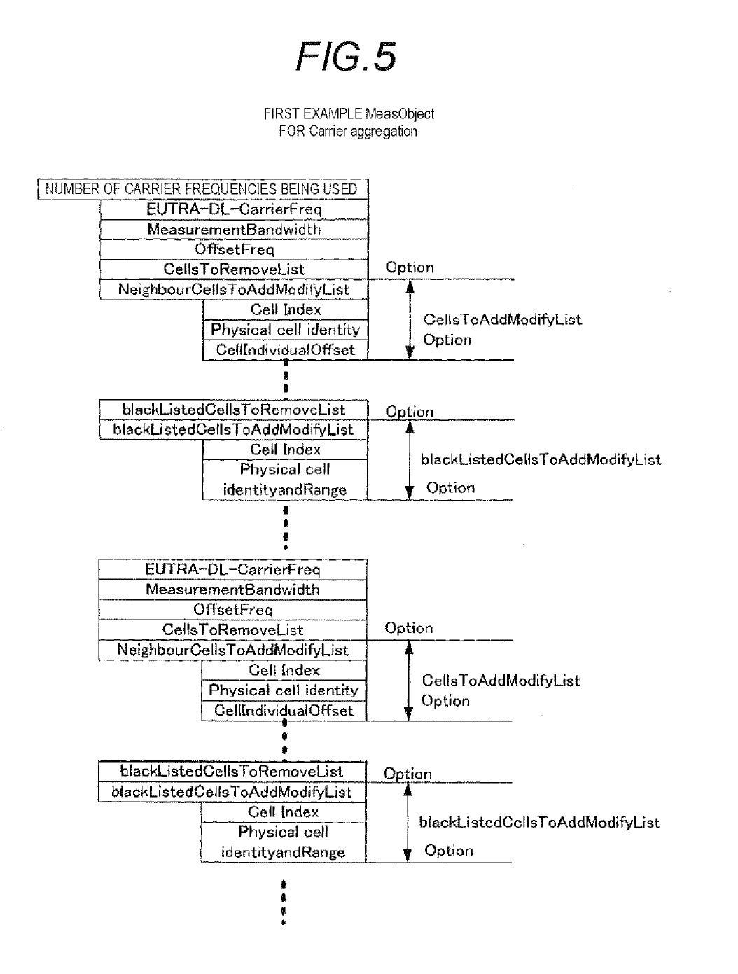

FIG. 5 shows example MeasObject achieved during carrier aggregation as an example measurement configuration achieved during carrier aggregation. FIG. 5 is a chart showing example MeasObject achieved during carrier aggregation in the communication system according to the first embodiment. As shown in FIG. 5, normal MeasObject takes only one carrier frequency as a target. However, as a result of addition of the number of carrier frequencies being used, a plurality of carrier frequencies can be taken as measurement targets.

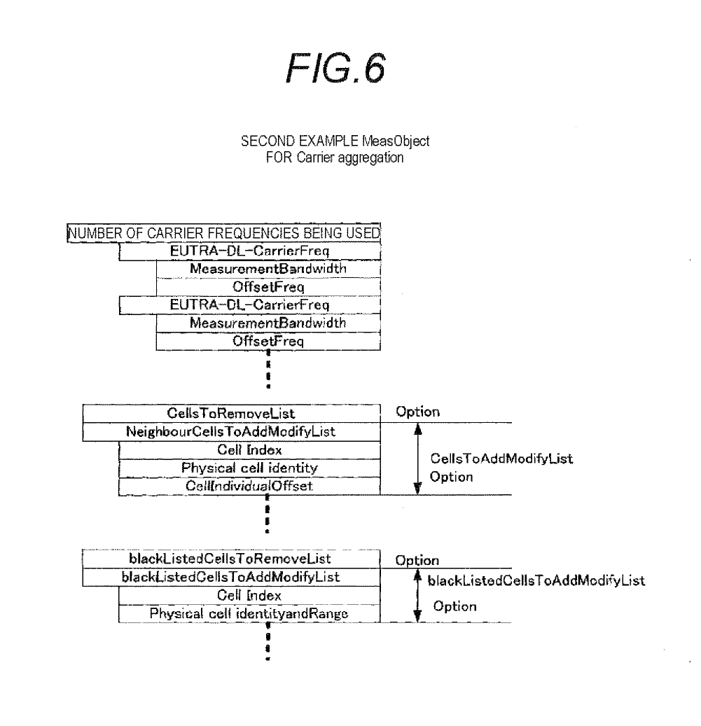

FIG. 6 is a chart showing another example MeasObject achieved during carrier aggregation in the communication system according to the first embodiment. In the example shown in FIG. 5, each of the carrier frequencies includes information about a list of neighbor cells and blacklisted cells. As show in FIG. 6, however, the carrier frequencies are associated with each other in terms of cell identifiers, whereby the information about a list of neighbor cells and the blacklisted cells pertaining to one carrier frequency can be shared.

The controller 105 holds a cell pair manager 107 and manages information about a pair of cells transmitted from the base station 200 or previously-retained information about a pair of cells. During carrier aggregation, the controller 105 averages measurement results by means of the pair of cells managed by the cell pair manager 107. When decided to determine an event, the controller outputs information about the pair of cells to the measurement result report determination section.

There is shown an example in which the controller 105 averages measurement results for the pair of cells, thereby determining performance of event determination. For instance, when carrier aggregation is performed by use of a neighbor carrier frequency, the measurement results are averaged for the pair of cells, whereby event determination is determined to be carried out. In the other cases, event determination is determined to be performed by means of a measurement result of an individual cell. Further, when a difference between carrier frequencies used for carrier aggregation is xMHz (e.g., x=20) or less, measurement results are averaged for the pair of cells, whereby event determination is determined to be carried out. In the other cases, from a measurement result of an individual cell, event determination is determined to be carried out. Further, when carrier aggregation is performed at the same frequency band; for instance, 800 MHz band and 2 GHz band, measurement results are averaged for the pair of cells, thereby determining that event determination is carried out. When carrier aggregation is performed while the 800 MHz band and the 2 GHz band are mixed, event determination is determined to be carried out by means of a measurement result of the individual cell. By doing so, quality can be made stable at the time of preparation of a pair of cells. The pair of cells is used for adding (averaging) measurement results for each pair of cells, to thus reduce a size of the measurement result report.

When received an input of a measurement result and information necessary to prepare a measurement result from the measurement result report determination section 103, the controller 105 outputs to the measurement result report preparation section 109 the measurement result and the information necessary to prepare the measurement result.

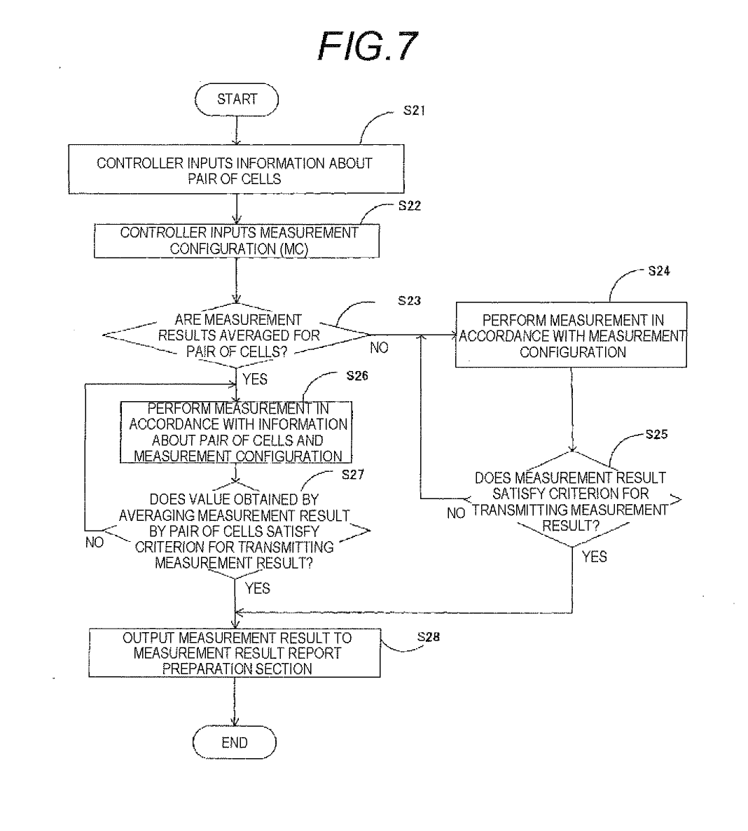

Referring to FIG. 7, a method for determining a measurement result report achieved during carrier aggregation is now described. FIG. 7 is a flowchart showing a method for determining a measurement result report produced during carrier aggregation.

In step S21, the measurement result report determination section 103 receives an input of information about a pair of cells from the controller 105. Processing proceeds to step S22.

In step S22, the measurement result report determination section 103 receives an input of a measurement configuration from the controller 105. Processing proceeds to step S23.

In step S23, the measurement result report determination section 103 determines whether or not to perform event determination by use of a value obtained by averaging measurement results for the pair of cells, according to the information about the pair of cells and the measurement configuration input by the controller 105. When event determination is performed by use of the value obtained by averaging the measurement results for the pair of cells, processing proceeds to step S26. When event determination is performed by means of the measurement result of the individual cell, processing proceeds to step S24.

In step S24, the measurement result report determination section 103 performs measurement on the basis of the measurement configuration input by the controller 105. Processing proceeds to step S25.

In step S26, the measurement result report determination section 103 performs measurement on the basis of the information about the pair of cells and the measurement configuration input by the controller 105. Processing proceeds to step S27.

In step S27, the measurement result report determination section 103 determines whether or not the value obtained by averaging the measurement results for the pair of cells satisfies the criterion for transmitting the measurement result to the base station 200. When the value satisfies the criterion, processing proceeds to step S28. On the contrary, when the value does not satisfy the criterion, processing returns to step S26.

In step S28, the measurement result report determination section 103 outputs as a measurement result to the measurement result report preparation section 109 the value obtained by averaging the measurement results for the pair of cells. Although the embodiment shows the exemplification in which event determination is performed by use of the value obtained by averaging the measurement results for the pair of cells, event determination pertaining to a measurement result can also be performed by use of a measurement result of an individual cell. Further, a measurement result report can also be prepared on the basis of the information about the pair of cells and by use of the value obtained by averaging the measurement results for the pair of cells. Although the embodiment shows the exemplification in which event determination is performed by use of the value obtained by averaging measurement results for the pair of cells, event determination pertaining to a measurement result can also be performed by use of a measurement result of an individual cell. Even when the measurement result report is determined to be sent in connection with both of the cells belonging to the pair of cells, only the measurement result of the cell exhibiting a superior measurement result (quality) can be included in the measurement result report.

### First Embodiment: Example Pair of Cells

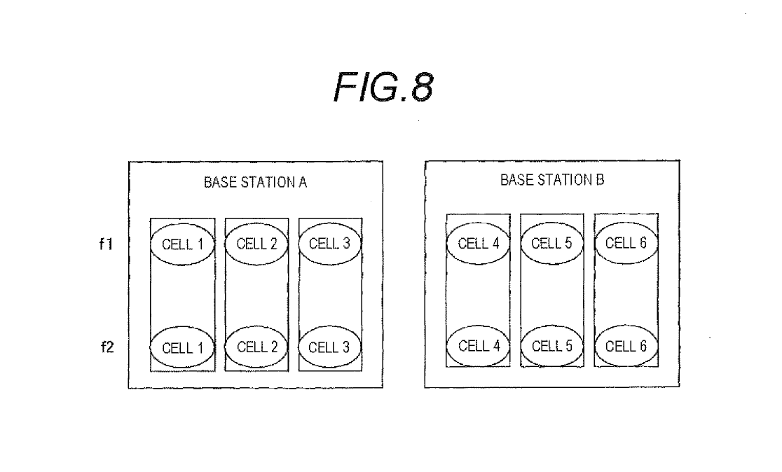

An example pair of cells is now described by reference to FIG. 8. FIG. 8 is an illustration showing an example pair of cells in the communication system according to the first embodiment. Numerals falling within the same range are independently allocated to PCIs of the cells among carrier frequencies. In order to simplify explanations, cells that belong to the same base station and the same area and that are assigned different carrier frequencies are assumed to be have the same PCIs. Accordingly, in relation to a pair of cells, a cell 1 that belongs to a base station 200A and that has a carrier frequency f1 and a cell 1 that belongs to the same base station and that has a carrier frequency f2 are taken as a pair. Likewise, cells 2 and cells 3 belonging to the base station 200A are taken as pairs, respectively. Further, cells 4, cells 5, and cells 6 belonging to a base station 200B are likewise taken as pairs, respectively. An example method for acquiring information about the pairs of cells is now described. In the case of cells that belong to the same base station and the same area, the cells become analogous to each other in terms of their characteristics, so long as carrier frequencies of the cells are close to each other. For this reason, it is possible to reduce a size of a measurement result report by utilization of a low possibility of occurrence of a big difference in two measurement results. In relation to allocation of a PCI, cells that belong to the same base station 200 and the same area and that have different carrier frequencies are allocated the same PCI. This yields an advantage of obviating a necessity to transmit information about a pair of cells from the base station 200 to the terminal 100. Even when cells differ from each other in terms of a size, the cells can also be deemed to belong to the same area, so long as the cells are located in the same direction from the base station. A PCI by means of which cells are paired can be transmitted as control information from the base station 200 to the terminal 100, thereby letting the terminal 100 perform measurement by use of the pair of cells desired by the base station 200. Allocation of the PCI performed at this time can also differ from that mentioned above. Information about the cells that are paired up with each other can also be transmitted in the form of “y” bits (e.g., y=1) from the base station 200 to the terminal 100.

In a case where one base station broadens a coverage by placing an antenna at a distant location in much the same way of a remote radio head, if antennas placed at different locations use the same cell ID at the same frequency, the terminal will unconsciously add (or average) measurement results of the respective cells and send a report to the base station. Moreover, when the terminal is conscious about existence of the remote radio head from timing or information sent from the base station, the terminal can consciously add (or average) measurement results of the cells acquired from respective antennas having the same frequency and send a report to the base station.

In a case where one base station broadens a coverage by placing an antenna at a distant location in much the same way of a remote radio head, if antennas placed at different locations use different cell IDs at the same frequency, the terminal will recognize, from information sent from the base station that the nature of the base station is a remote radio head. Finally, the terminal can consciously add (or average) measurement results of the cells acquired from the respective antennas having the same frequency and send a report to the base station.

With the configuration, when a cooperative relay between antennas is performed, measurement results of cells that are concurrently used are added (or averaged), whereby more accurate measurement results can be sent to the base station. The above descriptions provide the case where the base station uses the antennas placed at remote locations and where the same base station manages the antennas located at a plurality of points. However, the same can also apply to base stations. When cooperative relay between base stations is performed, the pair of cells can also belong respectively to different base stations and have different frequencies.

The measurement result report preparation section 109 prepares a measurement result report (Measurement Report) from the measurement result input by the measurement result report determination section 103 or the controller 105 and information necessary to prepare the measurement result. The measurement result report preparation section 109 outputs the thus-prepared measurement result report (Measurement Report) to the transmitter 111.

### First Example Measurement Result Report (Measurement Report)

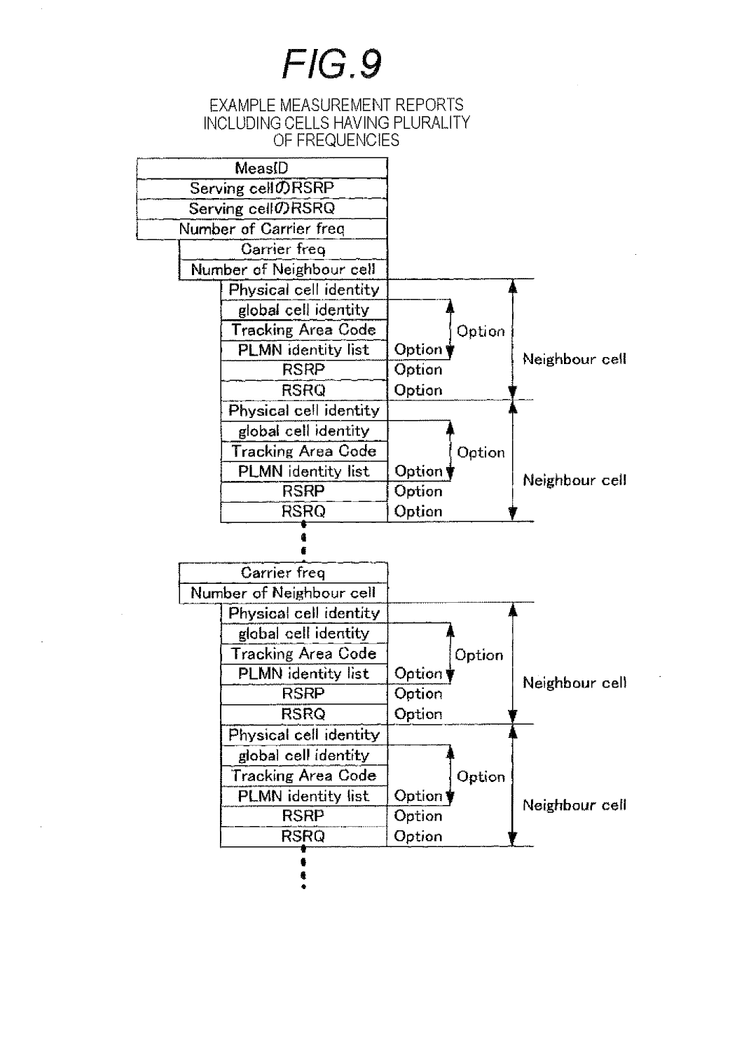

Referring to FIG. 9, an explanation is given to an example measurement result report (Measurement Report) achieved when the report is not provided for each pair of cells. FIG. 9 is a chart showing an example measurement result report (Measurement Report) not produced for each pair of cells in the communication system according to the first embodiment. As shown in FIG. 9, carrier frequencies are separated from each other, whereby cells having two carrier frequencies can be included in one measurement result report (Measurement Report). The base station can thereby determine handover from one measurement result report (Measurement Report). When the base station has a function of determining handover from two measurement result reports (Measurement Reports), the measurement result report (Measurement Report) can also be prepared for each carrier frequency.

### Second Example Measurement Result Report (Measurement Report)

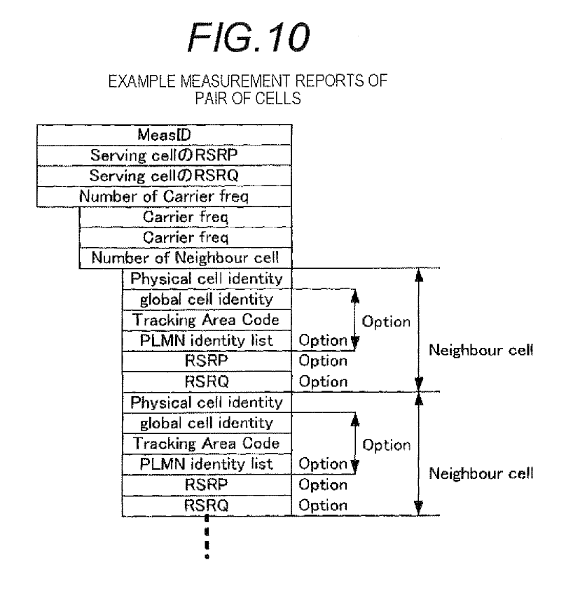

Referring to FIG. 10, an example measurement result report (Measurement Report) achieved for each pair of cells is now described. FIG. 10 is a chart showing an example measurement result report (Measurement Report) produced for each pair of cells in the communication system according to the first embodiment. As shown in FIG. 10, carrier frequencies of the paired cells are specified. Event determination is performed by use of a measurement result of an individual cell. When a measurement result report is described in a value obtained by averaging measurement results for a pair of cells in order to reduce the size of the measurement result report, it is also desirable to make it a rule to determine that an event has occurred in a cell having a carrier frequency first described in a measurement result report (Measurement Report) so that which one of carrier frequencies can be located as a frequency of a cell where the event has occurred.

### Third Example Measurement Result Report (Measurement Report)

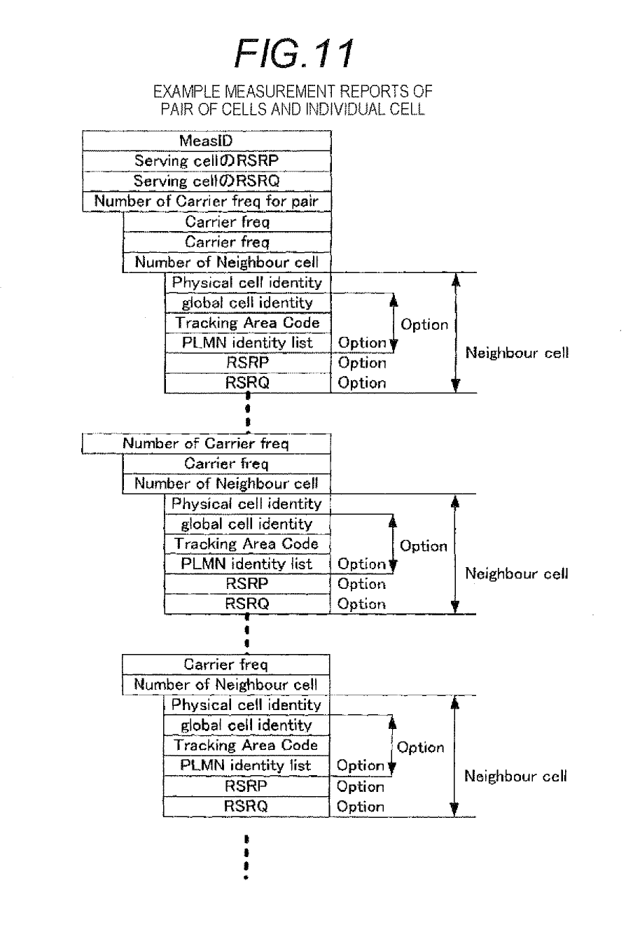

Referring to FIG. 11, an explanation is given to an example measurement result report (Measurement Report) achieved when a measurement result represented by a pair of cells and a measurement result of an individual cell mixedly exist. FIG. 11 is a chart showing an example measurement result report (Measurement Report) produced when a measurement result represented by a pair of cells and a measurement result represented by an individual cell mixedly exist in the communication system according to the first embodiment. Like a measurement result report (Measurement Report) shown in FIG. 11, the example measurement result report (Measurement Report) shown in FIG. 9 and the example measurement result report (Measurement Report) shown in FIG. 10 can be combined together.

### Fourth Example Measurement Result Report (Measurement Report)

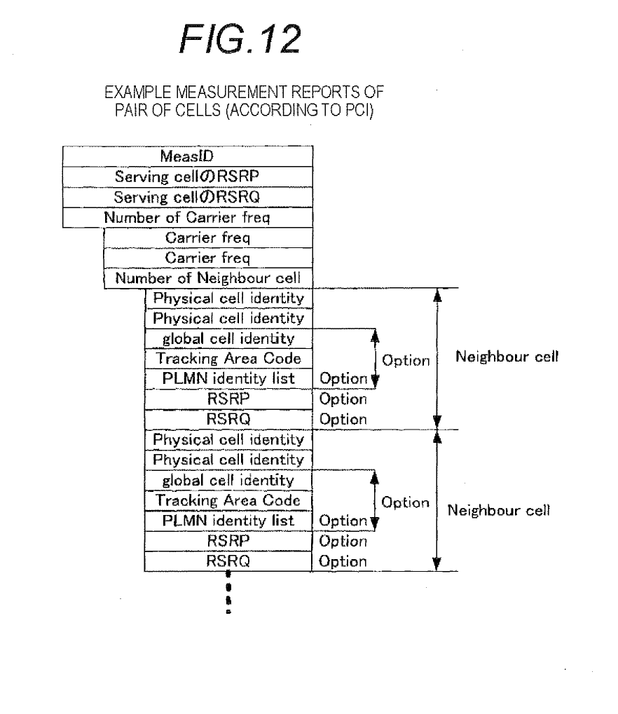

Referring to FIG. 12, an explanation is given to an example measurement result report (Measurement Report) acquired when PCIs of the pair of cells are not unified. FIG. 12 is a chart showing an example measurement result report (Measurement Report) produced when PCIs of the pair of cells in the communication system according to the first embodiment are not unified. As shown in FIG. 12, information about one Neighbor cell includes two physical cell identifiers. A sequence of entry of PCIs is written in conformance to a sequence of previously-described carrier frequencies. The frequencies and PCIs can be thereby mapped.

In the respective example measurement result reports (Measurement Reports) pertaining to the pair of cells described by reference to FIGS. 9 to 12, a global cell identifier is optionally included. However, when measurement results are represented by the pair of cells, the global cell identifier can be removed from a format, thereby reducing a format size. This is not limited to the global cell identifier, and an optional identifier can also be removed from the format, thereby reducing a format size. When the measurement results are averaged for the pair of cells, the measurement results are represented by RSRP. On the contrary, when the measurement results are not averaged for the pair of cells, the measurement results can also be represented by RSRQ, and information about whether or not its-own cells are a pair of cells can also be included in the information about one neighbor cell. The respective measurement result reports (Measurement Reports) shown in FIGS. 9 through 12 can also include bits for determining a format to be used.

The transmitter 111 transmits the measurement result report (Measurement Report) input by the measurement result report preparation section 109 to the base station 200.

[Configuration of the Base Station 200]

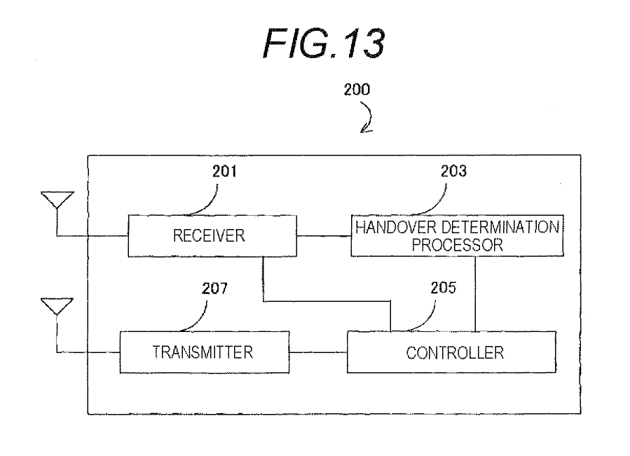

The configuration of the base station 200 is now described by reference to FIG. 13. FIG. 13 is a block diagram showing the configuration of the base station 200 described in connection with the first embodiment. The base station 200 includes a receiver 201, a handover determination processor 203, a controller 205, and a transmitter 207.

The receiver 201 outputs the measurement result report (Measurement Report) received from the terminal 100 to the handover determination processor 203.

The handover determination processor 203 determines, from the measurement result report (Measurement Report) input by the receiver 201, whether or not to perform handover (Intra-frequency Handover) to a base station other than the base station 200. Specifically, when the measurement result report (Measurement Report) is described by the pair of cells, the handover determination processor 203 determines whether or not to perform handover (Intra-frequency Handover) using the same frequency or handover (Inter-frequency Handover) using a frequency differing from that previously used, to another base station using two component carriers.

The controller 205 outputs to the transmitter 207 control information that is for transmitting a measurement configuration to the terminal 100 and schedule information about a reference signal. When the terminal 100 is in the middle of performing carrier aggregation, the controller 205 notifies the handover determination processor 203 that the terminal 100 is in the middle of performing carrier aggregation.

The transmitter 207 transmits the reference signal, the control information, and the like, to the terminal 100 in accordance with schedule information.

The present embodiment has provided the descriptions about the example in which the measurement result report (Measurement Report) is described in the value that is obtained by averaging measurement results for the pair of cells. There can also be adopted another method by means of which a plurality of results are integrated, by means of a technique other than averaging, into one result or at least results that are smaller in number than the original results, thereby reducing the quantity of information.

### Second Embodiment

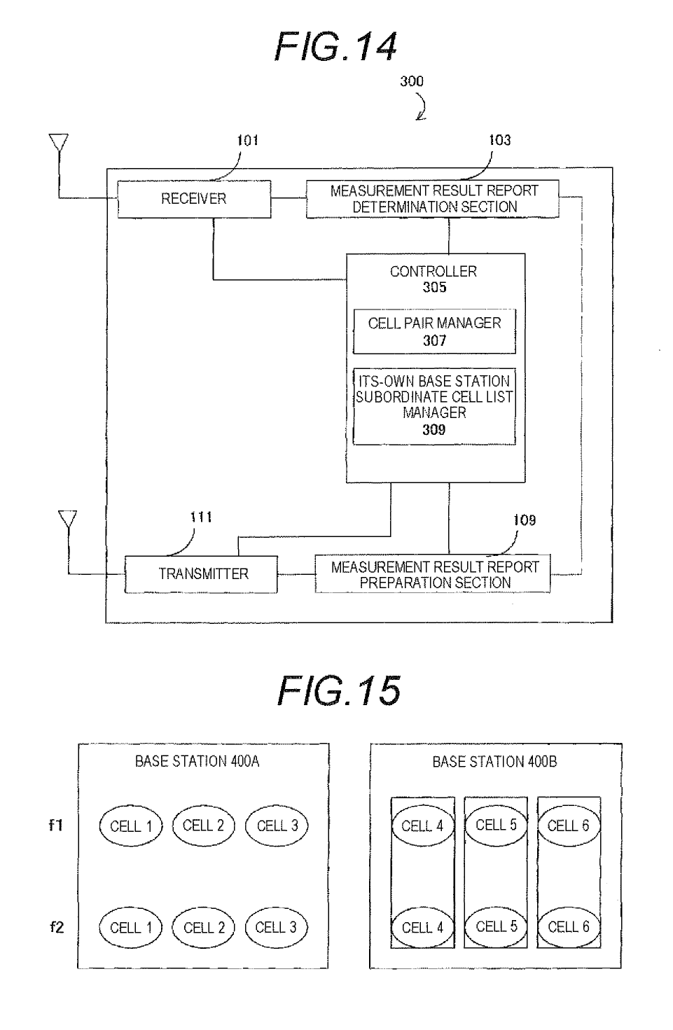

Referring to FIGS. 14 through 16, a wireless communication system of a second embodiment of the present invention is described. The wireless communication system according to the second embodiment of the present invention includes a terminal 300 and a base station 400.

In the wireless communication system according to the second embodiment, the terminal 300 has a function of receiving a reference signal transmitted on a per-cell basis from the base station 400 by means of a downlink and reporting, as a measurement result report (Measurement Report), a measurement result, which has been derived by a predetermined calculation formula, to the base station 400 by means of an uplink. The base station 400 also has a function of allocating and managing wireless resources (e.g., a frequency domain and a frequency band in a time domain) and performing handover when determined, from the measurement result report (Measurement Report) sent by the terminal 300, that handover to another cell is required. The base station 400 can also be said to work as an access point of a wireless access network for the terminal 300.

The present embodiment is based on the first embodiment and further provides descriptions about a wireless communication system in which measurement results of the cells subordinate to the base station to which a serving cell belongs are not averaged by the pair of cells and are individually sent, whereby appropriate cells are used in accordance with movement of the terminal into the base station.

[Configuration of the Terminal 300]

Referring to FIG. 14, a configuration of the terminal 300 according to the present embodiment is now described. FIG. 14 is a block diagram showing the configuration of the terminal 300 according to the second embodiment of the invention. The terminal 300 according to the second embodiment differs from the terminal 100 according to the first embodiment in the configuration of the controller. For this reason, constituent elements of the terminal 300 that are identical with their counterpart constituent elements of the terminal 100 described in connection with the first embodiment are assigned the same reference numerals, and their detailed descriptions are omitted here for brevity.

The terminal 300 according to the second embodiment has the receiver 101, the measurement result report determination section 103, a controller 305, the measurement result report preparation section 109, and the transmitter 111. The configuration of the controller 305 is now described, and detailed descriptions about the configuration of the terminal 300 other than that are omitted.

The controller 305 has a function of commanding the receiver 101 to receive system information, or the like, sent from the base station 200. The controller 305 has a function of outputting the control information output from the receiver 101 or a measurement configuration based on previously-incorporated control information to the measurement result report determination section 103 and commanding the measurement result report determination section 103 to output a measurement result based on the measurement configuration. Since the example measurement configuration are equivalent to the example measurement configuration shown in FIGS. 5 and 6 and described in connection with the first embodiment, their explanations are omitted.

The controller 305 has a cell pair manager 307. The cell pair manager 307 receives information about a pair of cells sent from the base station 200 or manages information about a previously-incorporated pair of cells.

The controller 305 has an its-own base station subordinate cell list manager 309. The its-own base station subordinate cell list manager 309 manages information, which is sent from the base station 400, about a list of cells subordinate to the its-own base station to which the terminal 300 is connected. The cell list information includes; for instance, a list of PCIs of cells, and is transmitted to a terminal while a flag showing that the same base station is shared is attached to a neighbor cell list in the system information sent from the base station to the terminal. In accordance with the information, the controller 305 can determine whether or not the cell belongs to the its-own base station. In relation to the cell subordinate to the base station to which the terminal belongs, the controller 305 determines, from the measurement result of the individual cell, to perform event determination. In relation to the other cells, the controller 305 determines, from a value obtained by averaging measurement results for the pair of cells, whether or not to perform event determination in the same way as in the first embodiment. The controller 305 has a function of outputting to the measurement result report determination section 103 information about a pair of cells in connection with event determination that is performed by means of averaging measurement results for the pair of cells.

### Second Embodiment: Example Pair of Cells

Referring to FIG. 15, an example pair of cells is now described. FIG. 15 is an illustration showing an example pair of cells in the present embodiment. Numerals falling within the same range are independently allocated to PCIs of cells among carrier frequencies. For the sake of simplicity of explanation, cells that belong to the same base station, that have different carrier frequencies, and that are located within the same area are assumed to be allocated the same PCIs.

As shown in FIG. 15, when a base station 400A is a serving base station, cells of the base station 400A are not paired in order to send measurement results of the respective cells. Since a base station 400B is not a serving base station, a cell 4 that belongs to the base station 400B and that has a carrier frequency f1 and a cell 4 that belong to the same and that has a carrier frequency f2 are paired up with each other. Likewise, cells 5 and cells 6 are paired up with each other. Thus, from information about pair of cells of the base station to which the terminal 300 does not belong and information about individual cells of the base station to which the terminal 300 belongs, the measurement result report preparation section 109 prepares combinations of cell pairs such as those shown in FIG. 15.

As mentioned above, in order to let its-own base station perform intra-base-station handover, the terminal 300 sends information about the individual cells. In order to let the other base station perform handover from a base station to another base station, the terminal 300 transmits information about combinations of cells including information about paired cells. As a result, the terminal 300 can reduce the size of a measurement result report (Measurement Report) and efficiently transmit a measurement result report (Measurement Report) to the base station 400.

[Configuration of the Base Station 400]

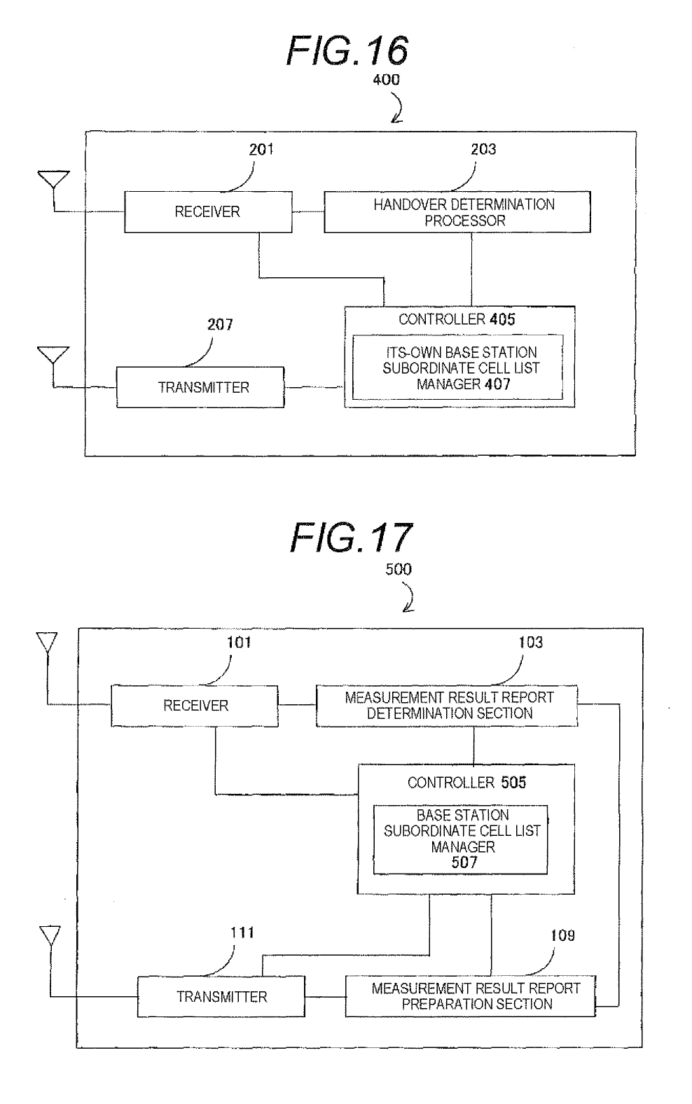

Referring to FIG. 16, a configuration of the base station 400 is now described. FIG. 16 is a block diagram showing the configuration of the base station 400 according to the second embodiment. A difference between the base station 400 according to the second embodiment and the base station 200 according to the first embodiment lies in the configuration of the controller. For this reason, constituent elements of the base station 400 that are identical with their counterpart constituent elements of the base station 200 described in connection with the first embodiment are assigned the same reference numerals, and their detailed descriptions are omitted here for brevity.

The base station 400 according to the second embodiment has the receiver 201, the handover determination processor 203, a controller 405, and the transmitter 207. The configuration of the controller 405 is now described, and detailed descriptions about the other configuration are omitted.

The controller 405 outputs control information for transmitting the measurement configuration to the terminal 300 and schedule information about a reference signal to the transmitter 207. When the terminal 300 performs carrier aggregation, the controller 405 notifies the handover determination processor 203 that the terminal 300 is in the course of performing carrier aggregation. In order to transmit information about a list of cells subordinate to the its-own base station to the terminal 300, the controller 405 fetches information about the list of cells subordinate to the its-own base station from its-own base station subordinate cell list manager 407. The controller 405 prepares control information including information about a list of cells subordinate to the its-own base station and outputs the thus-prepared information to the transmitter 207. The information about the list of cells subordinate to the its-own base station is transmitted to the terminal 300 at this time while a flag showing that the same base station is shared is attached to a neighbor cell list in the system information sent from the base station 400 to the terminal 300. Moreover, the information can also be transmitted to the terminal 300 while added to the system information as a list of PCIs of cells subordinate to the its-own base station. Alternatively, the information can also be transmitted as individual control information; namely, a list of PCIs of cells subordinate to the its-own base station.

### Third Embodiment

Referring to FIGS. 17 to 19, a wireless communication system of a third embodiment of the present invention is described. The wireless communication system according to the third embodiment of the present invention includes a terminal 500 and a base station 600.

The wireless communication system according to the third embodiment of the present invention can prepare a pair of cells that is required as a handover destination by the terminal from the list of cells subordinate to the base station, average measurement results, and transmit appropriate cells to the base station while reducing the size of a measurement result report (Measurement Report).

In the wireless communication system according to the third embodiment, the terminal 500 has a function of receiving a reference signal transmitted on a per-cell basis from the base station 600 by way of the downlink and reporting, as a measurement result report (Measurement Report), a measurement result derived from a predetermined calculation formula to the base station 600 by way of the uplink Further, the base station 600 has a function of allocating and managing wireless resources (e.g., a frequency domain and a frequency band in a time domain) and performing handover processing when determined, from the measurement result report (Measurement Report) reported by the terminal 500, that handover to another cell is required. Further, the base station 600 can also be said to work as an access point of a wireless access network for the terminal 500.

### [Configuration of the Terminal 500]

Referring to FIG. 17, a configuration of the terminal 500 of the embodiment is described. FIG. 17 is a block diagram showing the configuration of the terminal 500 according to the third embodiment. A difference between the terminal 500 according to the third embodiment and the terminal 100 according to the first embodiment lies in a configuration of the controller. For this reason, constituent elements of the terminal 500 that are identical with their counterpart constituent elements of the terminal 100 described in connection with the first embodiment are assigned the same reference numerals, and their detailed descriptions are omitted here for brevity.

The terminal 500 according to the third embodiment has the receiver 101, the measurement result report determination section 103, a controller 505, the measurement result report preparation section 109, and the transmitter 111. The configuration of the controller 505 is now described, and detailed descriptions about the configuration of the terminal other than that are omitted.

The controller 505 has a function of commanding the receiver 101 to receive system information, or the like, sent from the base station 600. The controller 505 has a function of outputting the control information output from the receiver 101 or a measurement configuration based on previously-incorporated control information to the measurement result report determination section 103 and commanding the measurement result report determination section to output a measurement result based on the measurement configuration. Since the example measurement configuration is equivalent to the example measurement configuration shown in FIGS. 5 and 6 and described in connection with the first embodiment, their explanations are omitted.

The controller 505 has a base station subordinate cell list manager 507. The base station subordinate cell list manager 507 manages a list of cells subordinate to the its-own base station to which the terminal 500 is connected, in which the list is sent from the base station 600, and a list of cells subordinate to another base station. The cell list information is made up of; for instance, a list of PCIs of cells, and transmitted to a terminal while a flag showing that the same base station is shared is attached to a neighbor cell list in the system information sent from the base station 600 to the terminal 500. In accordance with the information, the controller 505 can determine which one of the base stations is one to which the cell belongs.

From the list of cells subordinate to the base station sent from the base station 600, the controller 505 prepares a pair of cells appropriate for the terminal 500. In, for instance, a situation where a manner of arrangement of cells included in the cell list concurrently includes information about neighbor cells and where the terminal migrates between neighbor cells, a pair of cells capable of avoiding occurrence of useless handover is prepared. Moreover, for instance, in a situation where neighbor cells are determined by utilization of a history of cells through which the terminal has migrated and where the terminal migrates very often between the cells, a pair of cells capable of avoiding occurrence of useless handover is prepared. Further, a pair of high quality cells is selected by utilization of the history of cells through which the terminal has migrated. The pair of cells appropriate for the terminal 500 can be measured by selection of the pair in the manner as mentioned above, so that a probability of occurrence of handover to a pair of cells appropriate for the terminal 500 can be enhanced.

The controller 505 outputs the pair of cells prepared as mentioned above as information about a pair of cells to the measurement result report determination section.

### Third Embodiment: Example Pair of Cells

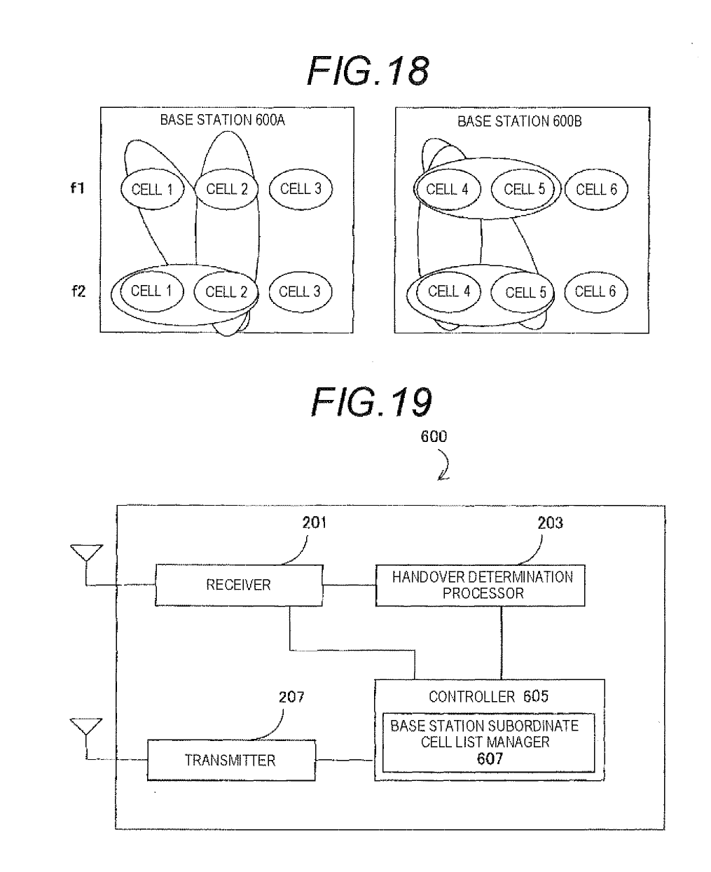

Referring to FIG. 18, an example pair of cells is now described. FIG. 18 is an illustration showing an example pair of cells in the present embodiment. Numerals falling within the same range are independently allocated to PCIs of the cells among carrier frequencies. For the sake of simplicity of explanation, cells that belong to the same base station, that have different carrier frequencies, and that are located within the same area are assumed to be allocated the same PCIs.

As shown in FIG. 18, when a cell 1 and a cell 2 are adjacent to each other within a base station 600A, the cell 1 having a carrier frequency f1 and the cell 2 having a carrier frequency f2 are taken as a pair of cells. Moreover, when a cell 4 and a cell 5 are adjacent to each other within a base station 600B, the cell 4 having a carrier frequency f1 and the cell 5 having a carrier frequency f2 are taken as a pair of cells.

Both pairs of cells, one pair belonging to the base station 600A and the other pair belonging to the base station 600B, can also be included in a measurement result report (Measurement Report), or a pair of cells belonging to one of the base stations can also be included in the report. Moreover, the number of pairs of cells is not limited to one pair of cells belonging to one base station, and two or more pairs of cells belonging to one base station can also be included. Further, a pair of cells is not limited to cells having different carrier frequencies, and cells having the same carrier frequencies can also be adopted. Furthermore, a pair of cells can also be a pair of cells of a plurality of antennas managed by the same base station. In addition, a pair of cells can also be a pair of cells belonging to different base stations that operate in a cooperative manner. Such a pair of cells can be implemented at this time, so long as which one of the base stations is performing cooperative operation is indicated or a list of cells subordinate to the base station is taken as a list of cells subordinate to the base station that is providing cooperative operation.

As mentioned above, the terminal 500 can efficiently transmit a measurement result report (Measurement Report) to the base station while reducing the size of the measurement result report (Measurement Report) by selective combination of high quality cells. In relation to cells subordinate to the its-own base station, the terminal 500 can also be arranged so as to individually transmit a measurement result without pairing up cells, thereby performing appropriate handover within the base station.

[Configuration of the Base Station 600]

Referring to FIG. 19, a configuration of the base station 600 is now described. FIG. 19 is a block diagram showing the configuration of the base station 600 according to the third embodiment. A difference between the base station 600 according to the third embodiment and the base station 200 according to the first embodiment lies in the configuration of the controller. For this reason, constituent elements of the base station 600 that are identical with their counterpart constituent elements of the base station 200 described in connection with the first embodiment are assigned the same reference numerals, and their detailed descriptions are omitted here for brevity.

The base station 600 according to the third embodiment has the receiver 201, the handover determination processor 203, a controller 605, and the transmitter 207. The configuration of the controller 605 is now described, and detailed descriptions about the other configuration are omitted.

The controller 605 outputs control information for transmitting the measurement configuration to the terminal 500 and schedule information about a reference signal to the transmitter 27. In order to send information about the list of cells subordinate to the base station to the terminal 500, the controller 605 fetches from a base station subordinate cell list manager 607 information about a list of cells subordinate to a base station. The controller 605 prepares control information including information about a list of cells subordinate to a base station and outputs the thus-prepared list to the transmitter 207. Information about the list of cells subordinate to the base station is transmitted to the terminal 500 while, for instance, a flag showing that the same base station is shared is attached to the neighbor cell list in the system information sent by the base station 600 to the terminal 500. Further, the information is transmitted to the terminal while being added as a list of PCIs of cells subordinate to a base station into the system information. Further, the information is transmitted as individual control information; namely, a list of PCIs of cells subordinate to a base station. When the terminal is in the course of performing carrier aggregation, the controller notifies the handover determination processor that the terminal is in the course of carrier aggregation.

Although the embodiment shows a method by means of which the terminal determines a superior combination of cells in the base station as a pair of cells, cells subordinate to the its-own base station are not paired up with each other, and measurement results are individually transmitted, whereby appropriate handover can be performed in the base station as described in connection with the second embodiment.

The present embodiment shows a method by means of which the terminal determines a superior combination in a base station as a pair of cells. However, in addition to the pair of cells described in connection with the method according to the first embodiment, a pair of superiorly combined cells in its-own base station can also be included.

The present embodiment shows a method by means of which the terminal determines a superior combination in a base station as a pair of cells. However, in addition to the pair of cells described in connection with the method according to the first embodiment, a superior combination of cells in its-own base station and a superior combination of cells in another base station can also be included as pairs of cells. The present embodiment shows a method by means of which the terminal determines a superior combination in a base station as a pair of cells. However, a pair of cells that is a superior combination in its-own base station described in connection with the third embodiment can be used for the cells in its-own base station, whilst the pair of cells conforming to the method described in connection with the first embodiment can also be used for cells of another base station.

The embodiment shows the example in which, when the terminal averages measurement results for the pair of cells, thereby preparing a measurement result report, the pair of cells averages measurement results by even at the time of determination of the measurement result report, to thus perform event determination, event determination can be individually performed at the time of event determination. After performance of event determination, cells subordinate to a single base station that exhibits high receiving power or high received quality can be selected in accordance with the list of cells subordinate to the base station and the measurement result, and a pair of cells that averages measurement results can also be prepared. Thus, the terminal can transmit a pair of cells exhibiting superior receiving quality to the base station while reducing the size of the measurement result report.

In the embodiment, event determination of a measurement result can also be performed by means of a measurement result of an individual cell. A measurement result report can be prepared by means of a pair of cells exhibiting superior receiving quality and can also be configured so as to include information about the pair of cells and measurement results of the cells that have exhibited superior measurement results.

### Fourth Embodiment

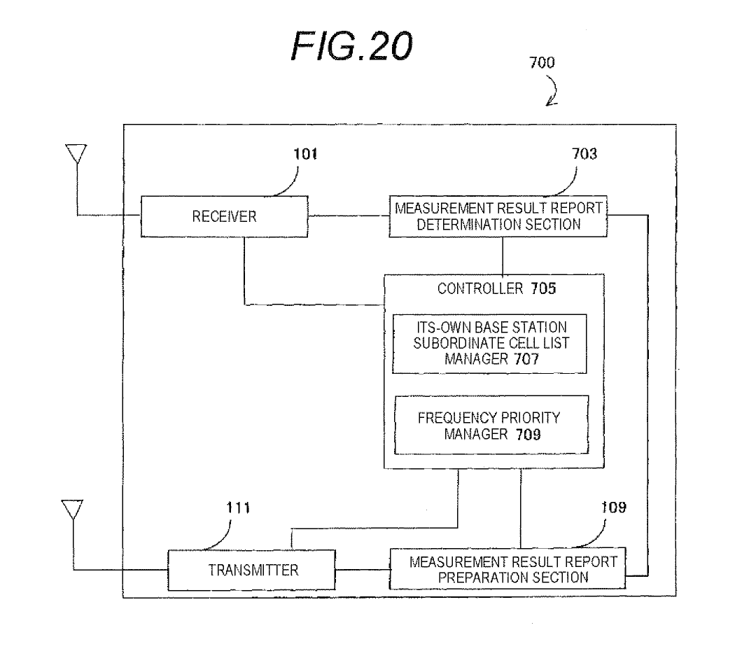

Referring to FIGS. 20 to 22, a wireless communication system according to a fourth embodiment of the present invention is described. The wireless communication system according to the fourth embodiment of the present invention is made up of a terminal 700 and a base station 800.

In the wireless communication system according to the present embodiment, from the viewpoint of a frequency priority and the list of cells subordinate to the its-own base station, only a cell having a high-priority frequency and a cell subordinate to the its-own base station are included in a measurement result report (Measurement Report). It thereby becomes possible to transmit to the base station information necessary to intra-base-station handover and handover from one base station to another base station while the size of the measurement result report (Measurement Report) is reduced.

In the wireless communication system according to the fourth embodiment of the present invention, the terminal 700 receives a reference signal transmitted per cell from the base station 800 by way of downlink and reports a measurement result derived by a predetermined calculation formula as a measurement result report (Measurement Result) to the base station 800 by way of uplink. The base station 800 allocates and manages wireless resources (e.g., a frequency domain and a frequency band in a time domain) and performs handover processing when determined, from the measurement result report (Measurement Report) reported by the terminal 700, that handover to a base station other than the base station 800 is required. Further, the base station 800 works as an access point of a wireless access network for the terminal 700.

### [Configuration of the Terminal 700]

Referring to FIG. 20, a configuration of the terminal 700 of the embodiment is described. FIG. 20 is a block diagram showing the configuration of the terminal 700 according to the fourth embodiment. A difference between the terminal 700 according to the fourth embodiment and the terminal 100 according to the first embodiment lies in a configuration of the measurement result report determination section and the configuration of the controller. For this reason, constituent elements of the terminal 700 that are identical with their counterpart constituent elements of the terminal 100 described in connection with the first embodiment are assigned the same reference numerals, and their detailed descriptions are omitted here for brevity.

The terminal 700 according to the fourth embodiment has the receiver 101, a measurement result report determination section 703, a controller 705, the measurement result report preparation section 109, and the transmitter 111. The configuration of the controller 705 is now described, and detailed descriptions about the configuration of the terminal other than that are omitted.

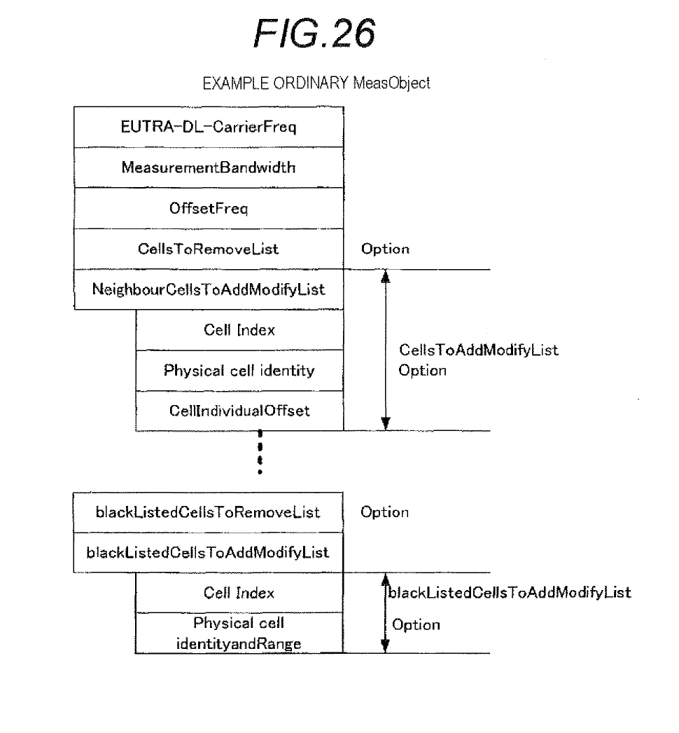

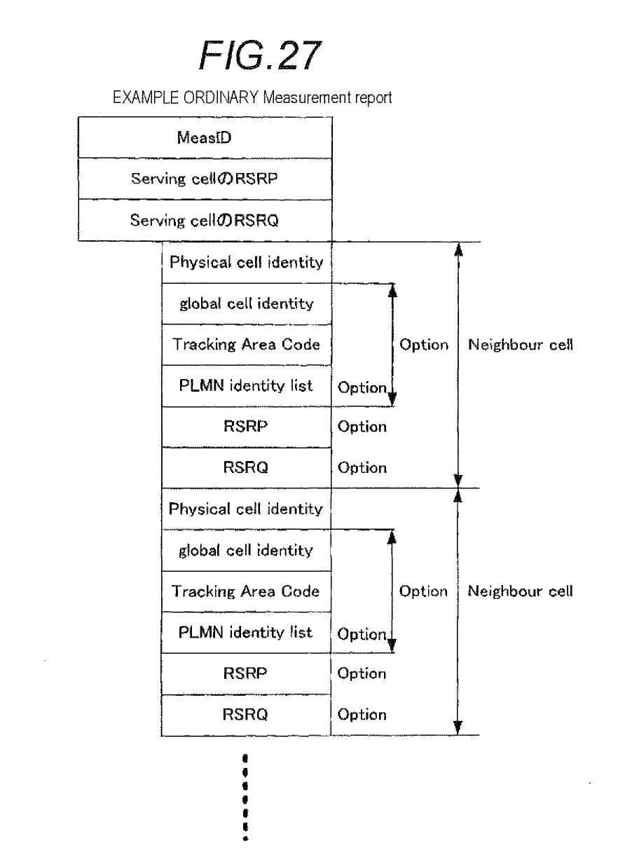

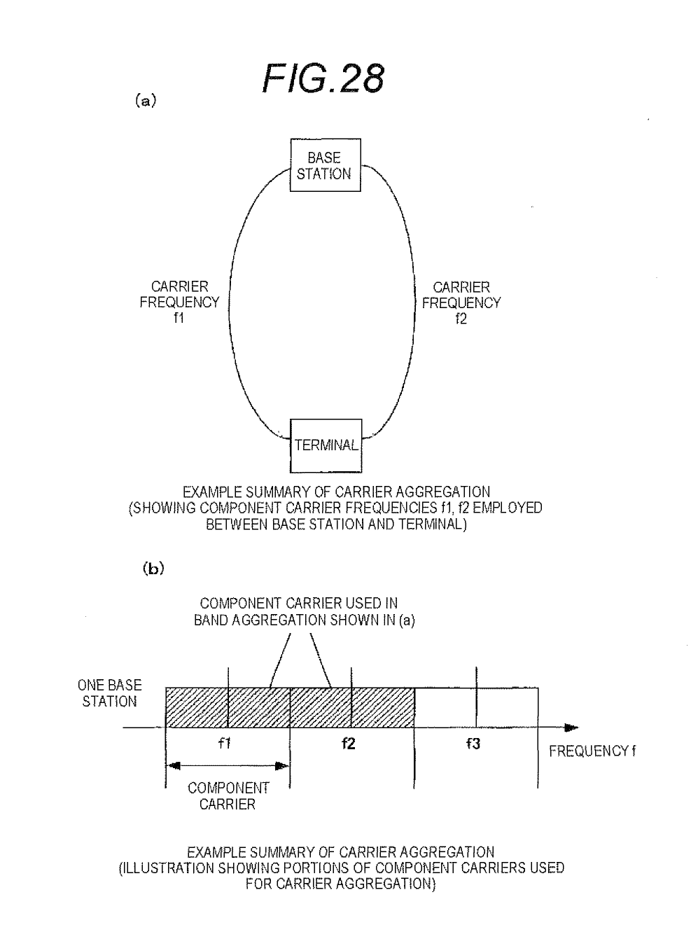

As shown in FIG. 26, it is also possible to send MeasObject of one frequency to the terminal and prevent occurrence of a measurement result report (Measurement Report) at anther frequency. Moreover, as shown in FIGS. 5 and 6, a plurality of frequencies are included, and a first described frequency may be prioritized. Further, a frequency having high priority can also be provided with a priority flag. As mentioned above, information about frequency priority can be provided, and a measurement result report (Measurement Report) can be formed from only a cell having the frequency. The size of the measurement result report (Measurement Report) can thereby be reduced.

The measurement result report determination section 703 has a function of individually managing measurement result output commands input by the controller 705; for instance, a command for periodically outputting a measurement result, a command for outputting a measurement result at the time of occurrence of an event, a command for periodically outputting a measurement result after occurrence of an event, a command for outputting a measurement result having a specific frequency, and a command for outputting a measurement result of a specific cell.

In accordance with a command from the controller 705, the measurement result report determination section 703 outputs a command for receiving a reference signal to the receiver 101. When a measurement result of the input reference signal corresponds to the command from the controller 705, the measurement result report determination section 703 outputs a measurement result corresponding to the command to the measurement result report preparation section 109.

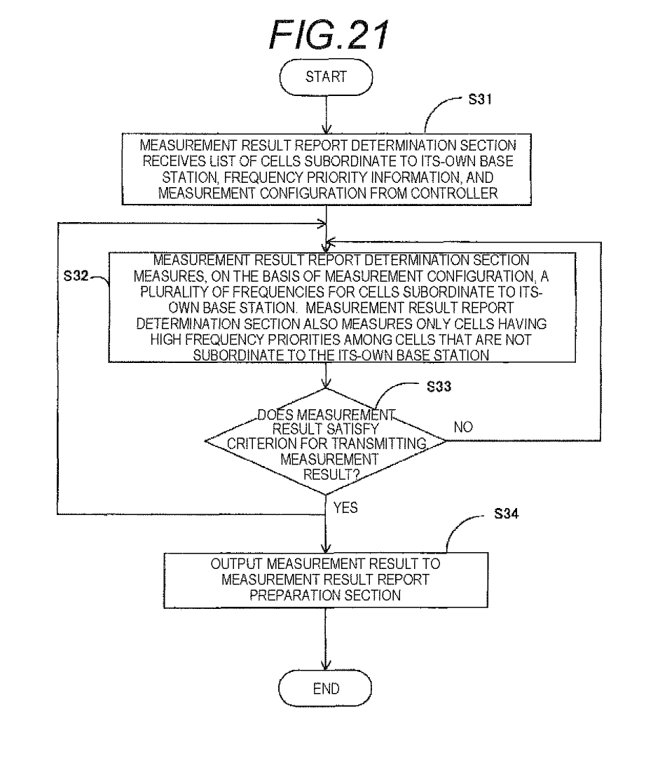

FIG. 21 is a flowchart showing a method for determining a measurement result report achieved during carrier aggregation. In step S31, the measurement result report determination section 703 receives from the controller 705 an input of the list of cells subordinate to the its-own base station, information about frequency priorities, and a measurement configuration. Processing proceeds to step S32.

In step S32, in relation to cells included in the list of cells subordinate to the its-own base station, the measurement result report determination section 703 performs measurement at a plurality of carrier frequencies on the basis of the list of cells subordinate to the its-own base station, information about frequency priorities, and the measurement configuration according to the measurement configuration. In relation to cells not included in the list of cells subordinate to the its-own base station, the measurement result report determination section measures only frequencies having high frequency priorities on the basis of the measurement configuration. The measurement result report determination section performs event determination by means of a measurement result of the measured cell. With this configuration, it is possible to perform handover to a cell subordinate to the its-own base station or handover to a cell subordinate to another base station while the size of the measurement result report is reduced. Processing proceeds to step S33.

In step S33, the measurement result report determination section 703 determines whether or not a measurement result of the cell satisfies a criterion for sending a measurement result to the base station 800. When the measurement result of the cell satisfies the criterion for transmitting a measurement result to the base station 800, processing proceeds to step S34. When the measurement result of the cell does not satisfy the criterion for transmitting a measurement result to the base station 800, processing returns to step S32.

In step S34, the measurement result report determination section 703 outputs the measurement result of the cell to the measurement result report preparation section 109.

Even after having outputted the measurement result and information necessary to prepare a measurement result report to the measurement result report preparation section 109, the measurement result report determination section 703 performs measurement on the basis of the measurement configuration. The measurement result report determination section 703 can also output a measurement result and information necessary to prepare the measurement result to the controller 705 rather than to the measurement result report preparation section 109.

The controller 705 has a function of commanding the receiver 101 to receive system information transmitted from the base station 800, or the like. The controller 705 also has a function of outputting the control information output from the receiver 101 or a measurement configuration based on previously-incorporated control information to the measurement result report determination section 703 and commanding the measurement result report determination section 703 to output a measurement result based on the measurement configuration.

The controller 705 has a frequency priority manager 709 and manages information about frequency priorities sent from the base station 800. Information about frequency priorities can also be explicitly sent from the base station to the terminal during; for instance, RRCConnectionSetup, or the like. Alternatively, as shown in FIG. 26, MeasObject having one frequency may also be transmitted to the terminal, and occurrence of Measurement Report at another frequency may also be prevented. Further, as shown in FIGS. 5 and 6, a plurality of frequencies are included, and a first described frequency may be prioritized. In addition, a frequency having high priority can also be provided with a priority flag. As mentioned above, information about frequency priority can be provided, and a measurement result report (Measurement Report) can be formed from only a cell having the frequency. The size of the measurement result report (Measurement Report) can thereby be reduced.

The controller 705 has an its-own base station subordinate cell list manager 707 and manages a list of cells subordinate to the its-own base station transmitted from the base station 800. The controller 705 determines, from the frequency priority information and the list of cells subordinate to the its-own base station, whether or not the measurement configuration is correct. Specifically, in relation to cells included in a list of cells subordinate to the its-own base station, measurement is performed at a plurality of carrier frequencies. In relation to cells that are not included in the list of cells subordinate to the its-own base station, a cell having high frequency priority performs measurement.

A measurement configuration are set at respective carrier frequencies to be subjected to measurement. Frequency priority information and the list of cells subordinate to the its-own base station are output to the measurement result report determination section. Thereby, in relation to the cells included in the list of cells subordinated to the its-own base station, the measurement result report determination section performs measurement at a plurality of carrier frequencies. in relation to cells that are not included in the list of cells subordinate to the its-own base station, a cell having high frequency priority is also arranged so as to perform measurement. With the result that, the information used for appropriately performing intra-base-station handover as well as the cell having high frequency priority can be transmitted from the terminal 700 to the base station 800.

Upon receipt of, from the measurement result report determination section 703, the measurement result or information to the effect that a measurement result is reported, the controller 705 outputs a frequency of a cell in which an event of transmission of the measurement result report to the measurement result report preparation section 109 has occurred; namely, a frequency having high frequency priority, to the measurement result report preparation section. Thereby, the measurement result report (Measurement Report) taking into account frequency priority can be prepared.

### [Configuration of the Base Station 800]

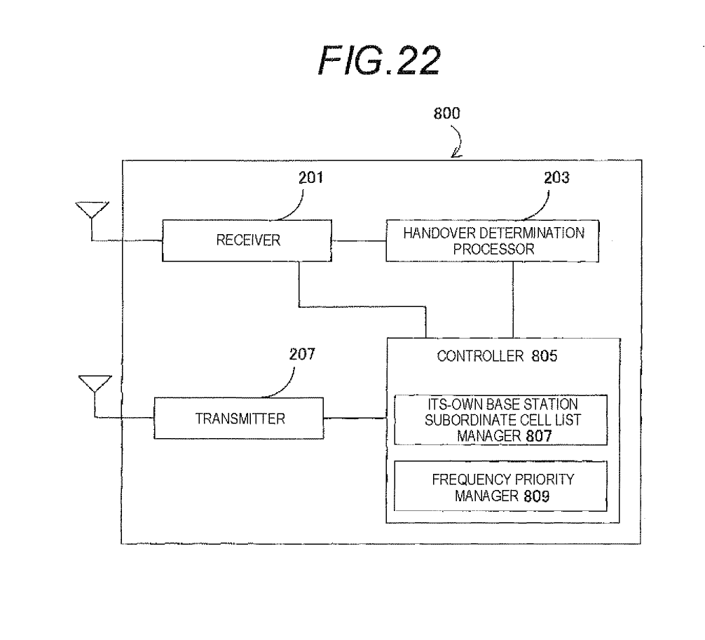

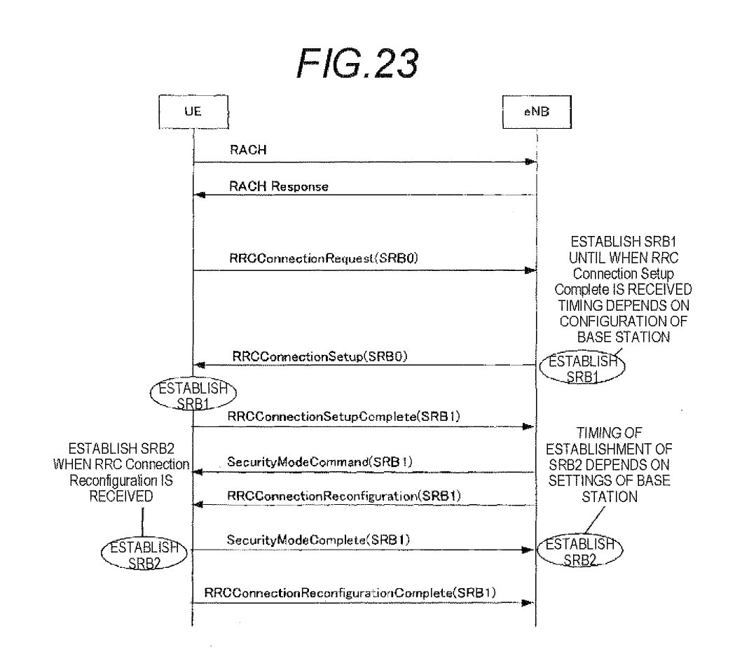

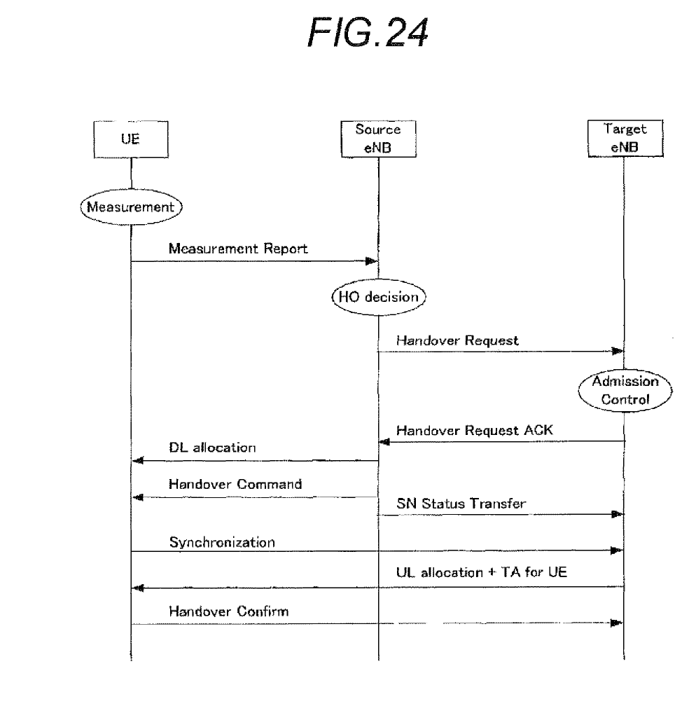

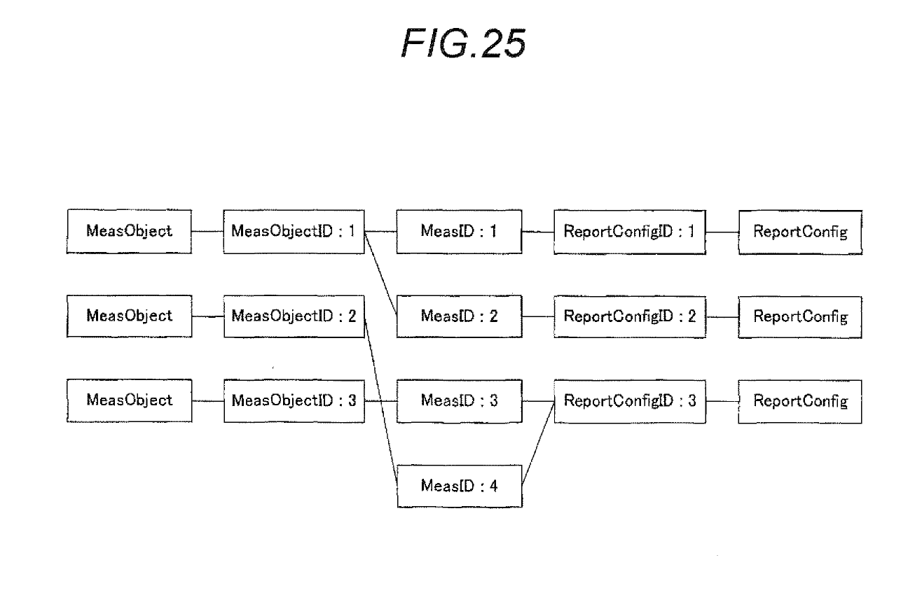

Referring to FIG. 22, a configuration of the base station 800 is now described. FIG. 22 is a block diagram showing the configuration of the base station 800 according to the fourth embodiment. A difference between the base station 800 according to the fourth embodiment and the base station 200 according to the first embodiment lies in a configuration of the controller. For this reason, constituent elements of the base station 800 that are identical with their counterpart constituent elements of the base station 200 described in connection with the first embodiment are assigned the same reference numerals, and their detailed descriptions are omitted here for brevity.

The base station 800 according to the fourth embodiment has the receiver 201, the handover determination processor 203, a controller 805, and the transmitter 207. The configuration of the controller 605 is now described, and detailed descriptions about the configuration of the terminal other than that are omitted.

The controller 805 has a frequency priority manager 809 that manages information about priority of frequencies subject to measurement performed by the terminal 700 and an its-own base station subordinate cell list manager 807 that manages a list of cells subordinate to the its-own base station.

The controller 805 prepares a measurement configuration based on information about frequency priorities and outputs the settings as control information to the transmitter 207. The measurement configuration can also be prepared while the cells subordinate to the its-own base station are also taken into account. Further, in order to explicitly transmit the information about frequency priorities to the terminal 700, the controller 805 can also prepare control information and output the information to the transmitter 207.

In order to transmit information about the list of cells subordinate to the its-own base station to the terminal 700, the controller 805 fetches the information about the list of cells subordinate to the its-own base station from the its-own base station subordinate cell list manager 807, prepares control information, and sends the information to the transmitter 207. When the terminal 700 is in the course of performing carrier aggregation, the controller 805 notifies the handover determination processor 203 that the terminal 700 is in the course of performing carrier aggregation.

The embodiments of the present invention have been described by reference to the exemplifications thus far. However, the scope of the present invention is not limited to the exemplifications and is susceptible to alterations or modifications according to the objective within the scope defined by the claims. For instance, the first through third embodiments have been separately described in the above. However, the scope of the present invention is not limited to the separate exemplification. The embodiments can also be used in combination.

The present patent application is based on Japanese Patent Application (No. 2009-086972) filed on Mar. 31, 2009, the entire subject matter of which is incorporated herein by reference.

The respective function blocks employed in the descriptions about the respective embodiments are typically implemented by means of an LSI that is an integrated circuit. These blocks can also be implemented in the form of single chips, respectively. Alternatively, the function blocks can also be implemented as a single chip that includes some or all of the functions. Although the LSI is mentioned, integration of the function blocks can also be called an IC, a system LSI, a super-LSI, or an ultra-LSI according to a degree of integration.

The technique for integrating the function blocks into circuitry is not limited to LSI technology, and the function blocks can also be implemented by means of a custom-designed circuit or a general-purpose processor. Further, an FPGA (Field Programmable Gate Array) capable of being programmed after manufacture of an LSI and a reconfigurable processor whose connections or settings of circuit cells in an LSI can be reconfigured can also be utilized.

Further, if a technique for integrating circuits replaceable with the LSI technology by virtue of advancement of the semiconductor technology or another technique derived from advancement of the semiconductor technology has emerged, the function blocks can naturally be integrated by use of the technique. Adaptation of biotechnology is feasible.

Although the invention has been described by reference to the antenna in the embodiments, an antenna port can also be applied likewise. The antenna port refers to a logical antenna that is built from one or a plurality of physical antennas. Specifically, the antenna port does not necessarily refer to one physical antenna and may refer to an arrayed antenna, or the like, built from a plurality of antennas. For instance, in LTE, the number of physical antennas making up the antenna port is not specified. The antenna port is defined as a minimum unit that enables a base station to transmit different reference signals. Further, the antenna port is sometimes specified as a minimum unit at which weighting on a precoding vector is multiplied.

Although the present invention has been described in detail and by reference to the specific embodiments, it is manifest to those skilled in the art that the present invention be susceptible to various alterations and modifications without departing the spirit and scope of the present invention.

The present patent application is based on Japanese Patent Application No. 2009-086972 filed on Mar. 31, 2009, the entire subject matter of which is incorporated herein by reference.

### INDUSTRIAL APPLICABILITY

As mentioned above, the present invention yields an advantage of controlling the size of a measurement result report by means of letting the measurement result report include useful information during carrier aggregation, to thus prevent an increase in the size; and hence is useful when handover is performed at high speed.

### REFERENCE SIGNS LIST

100, 300, 500, 700: TERMINAL

200, 400, 400A, 400B, 600, 600A, 600B: BASE STATION

101, 201: RECEIVER

103, 703: MEASUREMENT RESULT REPORT DETERMINATION SECTION

105, 205, 305, 405, 505, 605, 705, 805: CONTROLLER

107: CELL PAIR MANAGER

109: MEASUREMENT RESULT REPORT PREPARATION SECTION

111, 207: TRANSMITTER

203: HANDOVER DETERMINATION PROCESSOR

507, 607: BASE STATION SUBORDINATE CELL LIST MANAGER

407, 707, 807: ITS-OWN BASE STATION SUBORDINATE CELL LIST MANAGER

709: FREQUENCY PRIORITY MANAGER

809: PRIORITY MANAGER

1-10. (canceled)

11. A wireless communication apparatus, comprising:
a receiver that receives a reference signal and control information from a wireless communication base station;
a measurement result report determination section that determines, from a measurement result of the reference signal measured in accordance with a predetermined measurement configuration, whether or not to transmit a measurement result report to the wireless communication base station;
a measurement result report preparation section that prepares the measurement result report to be reported to the wireless communication base station;
a controller that controls the measurement result report determination section and the measurement result report preparation section in accordance with the control information; and
a transmitter that transmits the measurement result report to the wireless communication base station, wherein,
when establishing wireless communication with the wireless communication base station by use of a plurality of cells of the wireless communication base station, the controller determines whether to control the measurement result report preparation section so as to prepare the measurement result report by grouping measurement results of at least two cells of the plurality of cells or to control the measurement result report preparation section so as to prepare the measurement result report while including the measurement results of the plurality of respective cells.

12. The wireless communication apparatus according to claim 11, wherein
the controller further includes an its-own base station subordinate cell list manager that manages a list of cells, among the plurality of cells, subordinate to a wireless communication base station to which the wireless communication apparatus itself is connected,
the controller controls the measurement result report preparation section so as to prepare the measurement result report while including the measurement results of respective cells, among the plurality of cells, subordinate to the wireless communication base station to which the wireless communication apparatus itself is connected, and
the controller determines whether to control the measurement result report preparation section so as to prepare the measurement result report by grouping measurement results of at least two cells, among the plurality of cells, that are not subordinate to the wireless communication base station to which the wireless communication apparatus itself is connected or to control the measurement result report preparation section so as to prepare the measurement result report while including the measurement results of the respective cells.

13. The wireless communication apparatus according to claim 11, wherein
the controller further includes a base station subordinate cell list manager that manages a list of its-own base station cells subordinate to a wireless communication base station to which the wireless communication apparatus itself is connected and a list of other base station cells subordinate to another wireless communication base station to which the wireless communication apparatus itself is not connected, and
the controller determines whether to control the measurement result report preparation section so as to prepare the measurement result report by grouping measurement results of at least two cells of the plurality of cells in accordance with a measurement result of the reference signal, and the list of its-own base station and the list of other base station cells managed by the base station subordinate cell list manager or to control the measurement result report preparation section so as to prepare the measurement result report while including the measurement results of the plurality of respective cells.

14. A wireless communication apparatus, comprising:
a receiver that receives a reference signal and control information from a wireless communication base station;
a measurement result report determination section that determines, from a measurement result of the reference signal measured in accordance with a predetermined measurement configuration, whether or not to transmit a measurement result report to the wireless communication base station;
a measurement result report preparation section that prepares the measurement result report to be reported to the wireless communication base station;
a controller that controls the measurement result report determination section and the measurement result report preparation section in accordance with the control information; and
a transmitter that transmits the measurement result report to the wireless communication base station, wherein,
when establishing wireless communication with the wireless communication base station by use of a plurality of cells of the wireless communication base station, the measurement result report determination section determines whether or not to transmit the measurement result report to the wireless communication base station in accordance with a value into which the measurement results of at least two cells of the plurality of cells are grouped.

15. The wireless communication apparatus according to claim 14, wherein
the controller further includes an its-own base station subordinate cell list manager that manages a list of cells, among the plurality of cells, subordinate to a wireless communication base station to which the wireless communication apparatus itself is connected,
the controller controls the measurement result report determination section in accordance with the measurement results of respective cells, among the plurality of cells, subordinate to the wireless communication base station to which the wireless communication apparatus itself is connected and the control information, and
the measurement result report determination section determines whether or not to transmit the measurement result report to the wireless communication base station in accordance with a value obtained by grouping measurement results of at least two cells, among the plurality of cells, not subordinate to the wireless communication base station to which the wireless communication apparatus itself is connected, and also determines whether or not to transmit the measurement result report to the wireless communication base station in accordance with measurement results of respective cells, among the plurality of cells, subordinate to the wireless communication base station to which the wireless communication apparatus itself is connected.

16. The wireless communication apparatus according to claim 14, wherein
the controller further includes a base station subordinate cell list manager that manages a list of its-own base station cells, among the plurality of cells, subordinate to the wireless communication base station to which the wireless communication apparatus itself is connected and a list of other base station cells, among the plurality of cells, subordinate to another wireless communication base station to which the wireless communication apparatus itself is not connected,
the controller controls the measurement result report determination section in accordance with the control information and the list of its-own base station cell and the list of other base station cell managed by the base station subordinate cell list manager, and
the measurement result report determination section determines whether or not to transmit the measurement result report to the wireless communication base station in accordance with a value into which the measurement results pertaining to at least two cells of the plurality of cells are grouped.

17. A wireless communication base station, comprising:
a receiver that receives the measurement result report transmitted from the wireless communication apparatus as defined in claim 11; and
a handover determination processor that determines whether or not to change a communication destination of the wireless communication apparatus from a cell of the current communication destination to another cell in accordance with the measurement result report received by the receiver.

18. A wireless communication base station, comprising:
a receiver that receives the measurement result report transmitted from the wireless communication apparatus as defined in claim 12; and
a handover determination processor that determines whether or not to change a communication destination of the wireless communication apparatus from a cell of the current communication destination to another cell in accordance with the measurement result report received by the receiver.

19. A wireless communication base station, comprising:
a receiver that receives the measurement result report transmitted from the wireless communication apparatus as defined in claim 13; and
a handover determination processor that determines whether or not to change a communication destination of the wireless communication apparatus from a cell of the current communication destination to another cell in accordance with the measurement result report received by the receiver.

20. A wireless communication system, comprising:
a wireless communication apparatus which includes:
a receiver that receives a reference signal and control information from a wireless communication base station;
a measurement result report determination section that determines, from a measurement result of the reference signal measured on a per-frequency basis in accordance with a predetermined measurement configuration, whether or not to transmit a measurement result report to the wireless communication base station;
a measurement result report preparation section that prepares the measurement result report to be reported to the wireless communication base station;
a controller that controls the measurement result report determination section and the measurement result report preparation section in accordance with the control information; and
a transmitter that transmits the measurement result report to the wireless communication base station, wherein,
when establishing wireless communication with the wireless communication base station by use of a plurality of cells of the wireless communication base station, the controller determines whether to control the measurement result report preparation section so as to prepare the measurement result report by grouping measurement results of at least two cells of the plurality of cells or to control the measurement result report preparation section so as to prepare the measurement result report while including measurement results of the plurality of respective cells; and
a wireless communication base station which includes:
a receiver that receives the measurement result report transmitted from the transmitter of the wireless communication apparatus; and
a handover determination processor that determines whether or not to change a communication destination of the wireless communication apparatus from a cell of the current communication destination to another cell in accordance with the measurement result report received by the receiver.

21. A wireless communication base station, comprising:
a receiver that receives the measurement result report transmitted from the wireless communication apparatus as defined in claim 14; and
a handover determination processor that determines whether or not to change a communication destination of the wireless communication apparatus from a cell of the current communication destination to another cell in accordance with the measurement result report received by the receiver.

22. A wireless communication base station, comprising:
a receiver that receives the measurement result report transmitted from the wireless communication apparatus as defined in claim 15; and
a handover determination processor that determines whether or not to change a communication destination of the wireless communication apparatus from a cell of the current communication destination to another cell in accordance with the measurement result report received by the receiver.

23. A wireless communication base station, comprising:
a receiver that receives the measurement result report transmitted from the wireless communication apparatus as defined in claim 16; and
a handover determination processor that determines whether or not to change a communication destination of the wireless communication apparatus from a cell of the current communication destination to another cell in accordance with the measurement result report received by the receiver.
